(19) United States
(12) Patent Application Publication
(10) Pub. No.: US 2024/0314646 A1
(43) Pub. Date: Sep. 19, 2024

(54) TERMINAL DEVICE, NETWORK NODE, AND METHODS THEREIN FOR HANDLING PATH SWITCH AND HANDOVER

(71) Applicant: Telefonaktiebolaget LM Ericsson (publ), Stockholm (SE)

(72) Inventors: Antonino Orsino, Kirkkonummi (FI); Zhang Zhang, Beijing (CN)

(21) Appl. No.: 18/578,376

(22) PCT Filed: May 13, 2022
(86) PCT No.: PCT/CN2022/092717

§ 371 Date: Jan. 11, 2024

(30) Foreign Application Priority Data
Jul. 30, 2021 (WO) PCT/CN2021/109898

(51) Int. Cl. H04W 36/00; H04W 76/27

(52) U.S. Cl. CPC H04W 36/0033; H04W 36/0058; H04W 76/27

(57) ABSTRACT

The present disclosure provides a method in a second terminal device, the second terminal device serving as a relay for a first terminal device towards a first network node or being a candidate to serve as a relay for the first terminal device towards the first network node or a second network node, the method comprising: transmitting a measurement report to the first network node or the second network node; receiving, from the first network node or the second network node, a handover command; and transmitting a first indication to the first terminal device, the first indication indicating that the second terminal device is performing a handover procedure.

### TECHNICAL FIELD

The present disclosure relates to communication technology, and more particularly, to a terminal device, a network node, and methods therein for handling path switch and handover.

### BACKGROUND

Sidelink (SL) transmissions over New Radio (NR) are specified by the 3rd Generation Partnership Project (3GPP) in Release 16, including enhancements of PROximity-based SErvices (ProSe) specified for Long Term Evolution (LTE). Four new enhancements are particularly introduced to NR sidelink transmissions as follows:

Support for unicast and groupcast transmissions is added in NR sidelink. For unicast and groupcast, a Physical Sidelink Feedback Channel (PSFCH) is introduced for a receiver User Equipment (UE), to reply a decoding status to a transmitter UE.

Grant-free transmissions, which are adopted in NR uplink transmissions, are also provided in the NR sidelink transmissions, to improve the latency performance.
To alleviate resource collisions among different sidelink transmissions launched by different UEs, it enhances channel sensing and resource selection procedures, which also leads to a new design of Physical Sidelink Control Channel (PSCCH).
To achieve a high connection density, congestion control and thus Quality of Service (QOS) management are supported in the NR sidelink transmissions.
   Layer 2 (L2) UE-to-Network Relay is defined in the 3GPP Technical Report (TR) 23.752, V1.0.0, which is incorporated herein for reference in its entirety. A protocol architecture supporting an L2 UE-to-Network Relay UE is provided. The L2 UE-to-Network Relay UE, or referred to as relay UE, provides forwarding functionality that can relay any type of traffic over a PC5 link. The L2 UE-to-Network Relay UE provides the functionality to support connectivity to the 5th Generation System (5GS) for Remote UEs. A UE is considered to be a Remote UE if it has successfully established a PC5 link to the L2 UE-to-Network Relay UE. A Remote UE can be located within Next Generation Radio Access Network (NG-RAN) coverage or outside of NG-RAN coverage.

As described 3GPP TR 38.836 V1.0.0, which is incorporated herein for reference in its entirety, an L2 UE-to-Network Relay uses the RAN2 principle of the Release15 NR handover procedure as the baseline Access Stratum (AS) layer solution to guarantee service continuity. For example, a network node, such as a (next) generation NodeB (gNB), may switch a remote UE to a target cell or target relay UE.

As described in 3GPP TS 38.300, V16.6.0, which is incorporated herein by reference in its entirety, for the purpose of service continuity, a UE may be handed over from a source gNB to a target gNB.

### SUMMARY

According to the Study Item (SI) related to sidelink relay and TR 23.752 and TR 38.836, a remote UE can have only one active connection at a time. This means that the remote UE can be connected, e.g., to a gNB, either via a direct Uu link or via a relay UE (by using the sidelink relay feature).

Accordingly, two different mobility procedures may be performed independently by a remote UE and a relay UE. The remote UE may perform a switching procedure (referred to as path switch in this context) by changing its active path from a direct Uu cell to a UE-to-Network relay or vice versa, or changing from one UE-to-Network relay to another UE-to-Network relay. The relay UE, on the other hand, may follow a normal Uu mobility procedure and thus may perform a handover procedure in order to change its current serving cell.

It may be problematic if a path switch procedure for a remote UE and a handover procedure for a relay UE occurs at the same time, e.g., at least overlap in time. For example, the path switch procedure for the remote UE may fail if its serving relay UE or candidate (target) relay UE has been handed over to another cell.

It is an object of the present disclosure to provide a terminal device, a network node, and methods therein for handing path switch and handover, capable of solving or at least mitigating the above problem.

According to a first aspect of the present disclosure, a method in a first terminal device is provided. The first terminal device has a second terminal device serving as a relay towards a first network node or being a candidate to serve as a relay towards the first network node or a second network node. The method includes: receiving a first indication from the second terminal device, the first indication indicating that the second terminal device is performing a handover procedure; and performing an operation in response to receiving the first indication.

In an embodiment, the operation may include: delaying, when a triggering criterion for transmitting a measurement report is fulfilled, transmission of the measurement report to the first network node.

In an embodiment, the operation of delaying may include: delaying the transmission of the measurement report by a predetermined time length.

In an embodiment, the operation of delaying may include: delaying the transmission of the measurement report until a second indication indicating that the handover procedure is completed is received from the second terminal device or the first network node.

In an embodiment, the operation may include: transmitting, when a triggering criterion for transmitting a measurement report is fulfilled, the measurement report to the first network node. The measurement report contains the first indication indicating that the second terminal device is performing the handover procedure.

In an embodiment, the operation may include, when a triggering criterion for transmitting a measurement report is fulfilled: initiating a cell reselection, relay discovery, or relay reselection procedure, or entering a Radio Resource Control (RRC) IDLE or INACTIVE state, without transmitting the measurement report to the first network node.

In an embodiment, the operation may include: changing a triggering criterion for transmitting a measurement report to be more difficult to be fulfilled.

In an embodiment, the triggering criterion may include at least one of a threshold, an offset, and a hypothesis.

In an embodiment, the measurement report may include one or more of: a first link measurement between the first terminal device and the first network node, a second link measurement between the first terminal device and the second network node, a third link measurement between the first terminal device and the second terminal device, and a fourth link measurement between the first terminal device and a third terminal device.

In an embodiment, the operation may include, when the second terminal device is the candidate to serve as the relay: transmitting, when a triggering criterion for transmitting a measurement report is fulfilled, a measurement report to the first network node. The measurement report includes a first link measurement between the first terminal device and the first network node and/or a second link measurement between the first terminal device and the second network node and/or a fourth link measurement between the first terminal device and a third terminal device, and excludes a third link measurement between the first terminal device and the second terminal device.

In an embodiment, the method may further include: receiving, from the first network node or another control device, an instruction or configuration to perform the operation in response to receiving the first indication.

In an embodiment, the first indication may be received directly from the second terminal device, or may be forwarded by a third terminal device, using: RRC signaling,

PC5 Signaling (PC5-S), discovery signaling, Medium Access Control (MAC) Control Element (CE), Layer 1 (L1) signaling, or control Protocol Data Unit (PDU) of a protocol layer.

In an embodiment, the first indication may be forwarded by the first network node using: RRC signaling, MAC CE, L1 signaling, or control PDU of a protocol layer.

In an embodiment, the first indication may be a one-bit indication, a Boolean value, or a field whose presence indicates that the second terminal device is performing the handover procedure.

According to a second aspect of the present disclosure, a method in a first terminal device is provided. The first terminal device has a second terminal device serving as a relay towards a first network node or being a candidate to serve as a relay towards the first network node or a second network node. The method includes: transmitting a measurement report to the first network node; receiving, from the first network node, an instruction to switch to a direct link with the first network node or the second network node or to a link towards the first network node or the second network node with the second terminal device as the relay; and transmitting a first indication to the second terminal device, the first indication indicating that the first terminal device is performing a switching procedure.

In an embodiment, the method may further include: receiving a second indication from the second terminal device, the second indication indicating that the second terminal device is performing a handover procedure; and aborting, when the second terminal device is serving as the relay, the switching procedure and initiating link reestablishment; or notifying, when the second terminal device is the candidate to serve as the relay, the first network node that the second terminal device is performing the handover procedure and/or that the second terminal device is no longer available as the candidate.

In an embodiment, the measurement report may include one or more of: a first link measurement between the first terminal device and the first network node, a second link measurement between the first terminal device and the second network node, a third link measurement between the first terminal device and the second terminal device, and a fourth link measurement between the first terminal device and a third terminal device.

In an embodiment, the first indication may be directly transmitted to the second terminal device, or may be transmitted to a third terminal device for forwarding to the second terminal device, using: RRC signaling, PC5-S, discovery signaling, MAC CE, L1 signaling, or control PDU of a protocol layer.

In an embodiment, the first indication may be transmitted to the first network node for forwarding towards the second terminal device, using: RRC signaling, MAC CE, L1 signaling, or control PDU of a protocol layer.

In an embodiment, the first indication may be a one-bit indication, a Boolean value, or a field whose presence indicates that the first terminal device is performing the switching procedure.

According to a third aspect of the present disclosure, a method in a second terminal device is provided. The second terminal device is serving as a relay for a first terminal device towards a first network node or is a candidate to serve as a relay for the first terminal device towards the first network node or a second network node. The method includes: receiving a first indication from the first terminal device, the first indication indicating that the first terminal device is performing a switching procedure to switch to a direct link with the first network node or the second network node or to a link towards the first network node or the second network node with the second terminal device as the relay; and performing an operation in response to receiving the first indication.

In an embodiment, the operation may include: delaying, when a triggering criterion for transmitting a measurement report is fulfilled, transmission of the measurement report to the first network node or the second network node.

In an embodiment, the operation of delaying may include: delaying the transmission of the measurement report by a predetermined time length.

In an embodiment, the operation of delaying may include: delaying the transmission of the measurement report until a second indication indicating that the switching procedure is completed is received from the first terminal device or the first network node or the second network node.

In an embodiment, the operation may include: transmitting, when a triggering criterion for transmitting a measurement report is fulfilled, the measurement report to the first network node or the second network node. The measurement report contains the first indication indicating that the first terminal device is performing the switching procedure.

In an embodiment, the operation may include, when a triggering criterion for transmitting a measurement report is fulfilled: transmitting the measurement report to the first network node or the second network node; receiving, from the first network node or the second network node, a handover command; and transmitting, to the first terminal device, a third indication indicating that the second terminal device is performing a handover procedure, and/or triggering release of a link between the first terminal device and the second terminal device.

In an embodiment, the operation may further include, subsequent to transmitting the third indication: transmitting, to the first network node, a fourth indication indicating that the third indication has been transmitted to the first terminal device.

In an embodiment, the operation may include: changing a triggering criterion for transmitting a measurement report to be more difficult to be fulfilled.

In an embodiment, the triggering criterion may include at least one of a threshold, an offset, and a hypothesis.

In an embodiment, the operation may include, when a triggering criterion for transmitting a measurement report is fulfilled: initiating a cell reselection, without transmitting the measurement report to the first network node or the second network node.

In an embodiment, the measurement report may include one or more of: a first link measurement between the second terminal device and the first or second network node, and a second link measurement between the second terminal device and a third network node.

In an embodiment, the method may further include: receiving, from the first network node, the second network node, or another control device, an instruction or configuration to perform the operation in response to receiving the first indication.

In an embodiment, the first indication may be received directly from the first terminal device, using: RRC signaling, PC5-S, discovery signaling, MAC CE, L1 signaling, or control PDU of a protocol layer.

In an embodiment, the first indication may be forwarded by the first network node or the second network node, using: RRC signaling, MAC CE, L1 signaling, or control PDU of a protocol layer.

In an embodiment, the first indication may be a one-bit indication, a Boolean value, or a field whose presence indicates that the first terminal device is performing the switching procedure.

According to a fourth aspect of the present disclosure, a method in a second terminal device is provided. The second terminal device is serving as a relay for a first terminal device towards a first network node or is a candidate to serve as a relay for the first terminal device towards the first network node or a second network node. The method includes: transmitting a measurement report to the first network node or the second network node; receiving, from the first network node or the second network node, a handover command; and transmitting a first indication to the first terminal device, the first indication indicating that the second terminal device is performing a handover procedure.

In an embodiment, the measurement report may include one or more of: a first link measurement between the second terminal device and the first or second network node, and a second link measurement between the second terminal device and a third network node.

In an embodiment, the first indication may be directly transmitted to the first terminal device, using: RRC signaling, PC5-S, discovery signaling, MAC CE, L1 signaling, or control PDU of a protocol layer.

In an embodiment, the first indication may be transmitted to the first network node or the second network node for forwarding towards the first terminal device, using: RRC signaling, MAC CE, L1 signaling, or control PDU of a protocol layer.

In an embodiment, the first indication may be a one-bit indication, a Boolean value, or a field whose presence indicates that the second terminal device is performing the handover procedure.

According to a fifth aspect of the present disclosure, a method in a first network node serving a first terminal device is provided. The first terminal device has a second terminal device serving as a relay towards the first network node or being a candidate to serve as a relay towards the first network node. The method includes: receiving a first measurement report from the first terminal device and determining based on the first measurement report that a first criterion for initiating a switching procedure for the first terminal device is fulfilled, the switching procedure being for the first terminal device to switch to a direct link with the first network node or a second network node or to a link towards the first network node with the second terminal device as the relay, and/or receiving a second measurement report from the second terminal device and determining based on the second measurement report that a second criterion for initiating a handover procedure for the second terminal device is fulfilled; and performing an operation in response to determining that the first criterion is fulfilled and/or determining that the second criterion is fulfilled.

In an embodiment, the operation may include: transmitting, to the first terminal device in response to determining that the second criterion is fulfilled, a first indication indicating that transmission of the first measurement report is prohibited; or transmitting, to the second terminal device in response to determining that the first criterion is fulfilled, a second indication indicating that transmission of the second measurement report is prohibited.

In an embodiment, the operation may further include: transmitting, to the first terminal device, a third indication indicating that transmission of the first measurement report is allowed, when the handover procedure is completed; or transmitting, to the second terminal device, a fourth indication indicating that transmission of the second measurement report is allowed, when the switching procedure is completed.

In an embodiment, the third indication may contain an identifier of a third network node to which the second terminal device has been handed over.

In an embodiment, the fourth indication may further indicate whether the first terminal device has switched to the direct link with the first network node or the second network node or to a link towards the first network node with the second terminal device as the relay.

In an embodiment, the operation may further include, in response to determining that the first criterion is fulfilled and determining that the second criterion is fulfilled: transmitting a first instruction to perform the switching procedure to the first terminal device, and transmitting a second instruction to perform the handover procedure to the second terminal device after the switching procedure is completed; or transmitting the second instruction to perform the handover procedure to the second terminal device, and transmitting the first instruction to perform the switching procedure to the first terminal device after the handover procedure is completed.

In an embodiment, the first instruction may be transmitted before the second instruction when the first measurement report is received before the second measurement report.

In an embodiment, the second instruction may be transmitted before the first instruction when the second measurement report is received before the first measurement report.

In an embodiment, the first instruction may be transmitted before the second instruction when the switching procedure has a higher priority than the handover procedure.

In an embodiment, the second instruction may be transmitted before the first instruction when the handover procedure has a higher priority than the switching procedure.

In an embodiment, the priority of the switching procedure may be dependent on a signal strength or quality of a serving link of the first terminal device, a Logical Channel (LCH) priority of a radio bearer on which the serving link of the first terminal device is operating, or a first fixed priority.

In an embodiment, the priority of the handover procedure may be dependent on a signal strength or quality of a serving link of the second terminal device, an LCH priority of a radio bearer on which the serving link of the second terminal device is operating, or a second fixed priority.

In an embodiment, the operation may include, when the second terminal device is serving as the relay: transmitting, in response to determining that the first criterion is fulfilled and determining that the second criterion is fulfilled, a second instruction to perform the handover procedure to the second terminal device and releasing a link between the first terminal device and the second terminal device.

In an embodiment, the operation may include: configuring, in response to determining that the first criterion is fulfilled and determining that the second criterion is fulfilled, the first terminal device and/or the second terminal device to enter an RRC_IDLE or RRC_INACTIVE state.

In an embodiment, the first measurement report may include one or more of: a first link measurement between the first terminal device and the first network node, a second link measurement between the first terminal device and the second network node, a third link measurement between the first terminal device and the second terminal device, and a fourth link measurement between the first terminal device and a third terminal device.

In an embodiment, the second measurement report may include one or more of: a fifth link measurement between the second terminal device and the first network node, and a sixth link measurement between the second terminal device and a third network node.

In an embodiment, the first measurement report may be received directly from the first terminal device, and/or the second measurement report is received directly from the second terminal device, using: RRC signaling, MAC CE, L1 signaling, or control PDU of a protocol layer.

According to a sixth aspect of the present disclosure, a method in a first network node serving a first terminal device is provided. The first terminal device has a second terminal device being a candidate to serve as a relay towards a second network node. The method includes: transmitting, to the first terminal device, an instruction or configuration to perform an operation in response to receiving an indication from the second terminal device, the indication indicating that the second terminal device is performing a handover procedure.

In an embodiment, the operation may include one or more of:
delaying, when a triggering criterion for transmitting a measurement report is fulfilled, transmission of the measurement report to the first network node,
initiating, when a triggering criterion for transmitting a measurement report is fulfilled, a cell reselection, relay discovery, or relay reselection procedure, or entering a Radio Resource Control, RRC, IDLE or INACTIVE state, without transmitting the measurement report to the first network node,
changing a triggering criterion for transmitting a measurement report to be more difficult to be fulfilled, and
transmitting, when the second terminal device is the candidate to serve as the relay and when a triggering criterion for transmitting a measurement report is fulfilled, a measurement report to the first network node, the measurement report including a first link measurement between the first terminal device and the first network node and/or a second link measurement between the first terminal device and the second network node and/or a fourth link measurement between the first terminal device and a third terminal device, and excluding a third link measurement between the first terminal device and the second terminal device.

According to a seventh aspect of the present disclosure, a method in a first network node serving a first terminal device is provided. The first terminal device has a second terminal device being a candidate to serve as a relay towards a second network node. The method includes: transmitting a first indication to the second network node, the first indication indicating that the first terminal device is performing a switching procedure to switch to a link towards the second network node with the second terminal device as the relay, or receiving a second indication from the second network node, the second indication indicating that the second terminal device is performing a handover procedure.

In an embodiment, the method may further include, in response to receiving the second indication: forwarding the second indication to the first terminal device; or transmitting, to the first terminal device, a third indication indicating that transmission of the first measurement report is prohibited.

In an embodiment, the method may further include: receiving, from the second network node, a fourth indication indicating that the handover procedure is completed; and forwarding the fourth indication to the first terminal device or transmitting, to the first terminal device, a fifth indication indicating that transmission of the first measurement report is allowed.

In an embodiment, the first indication may be transmitted and/or the second indication is received, using: X2/X1 signaling, F1 signaling, or RRC message.

In an embodiment, the first indication may be a one-bit indication, a Boolean value, or a field whose presence indicates that the first terminal device is performing the switching procedure.

In an embodiment, the second indication may be a one-bit indication, a Boolean value, or a field whose presence indicates that the second terminal device is performing the handover procedure.

According to an eighth aspect of the present disclosure, a method in a second network node serving a second terminal device is provided. The second terminal device is a candidate to serve as a relay for a first terminal device served by a first network node towards the second network node. The method includes: transmitting, to the second terminal device, an instruction or configuration to perform an operation in response to receiving an indication from the first terminal device, the indication indicating that the first terminal device is performing a switching procedure to switch to a link towards the second network node with the second terminal device as the relay.

In an embodiment, the operation may include one or more of:
delaying, when a triggering criterion for transmitting a measurement report is fulfilled, transmission of the measurement report to the second network node,
transmitting, when a triggering criterion for transmitting a measurement report is fulfilled, the measurement report to the second network node, the measurement report containing an indication indicating that the first terminal device is performing the switching procedure,
when a triggering criterion for transmitting a measurement report is fulfilled: transmitting the measurement report to the second network node, receiving, from the second network node, a handover command; and transmitting, to the first network node for forwarding to the first terminal device, an indication indicating that the second terminal device is performing a handover procedure,
changing a triggering criterion for transmitting a measurement report to be more difficult to be fulfilled,
initiating, when a triggering criterion for transmitting a measurement report is fulfilled, a cell reselection, without transmitting the measurement report to the second network node.

According to a ninth aspect of the present disclosure, a method in a second network node serving a second terminal device is provided. The second terminal device is a candidate to serve as a relay for a first terminal device served by a first network node towards the second network node. The method includes: transmitting a second indication to the first network node, the second indication indicating that the second terminal device is performing a handover procedure, or receiving a first indication from the first network node, the first indication indicating that the first terminal device is performing a switching procedure to switch to a link towards the second network node with the second terminal device as the relay.

In an embodiment, the method may further include, in response to receiving the first indication: forwarding the first indication to the second terminal device; or transmitting, to the second terminal device, a third indication indicating that transmission of the second measurement report is prohibited.

In an embodiment, the method may further include: receiving, from the first network node, a fourth indication indicating that the switching procedure is completed; and forwarding the fourth indication to the second terminal device or transmitting, to the second terminal device, a fifth indication indicating that transmission of the second measurement report is allowed.

In an embodiment, the second indication may be transmitted and/or the first indication may be received, using: X2/X1 signaling, F1 signaling, or inter-node RRC message.

In an embodiment, the first indication may be a one-bit indication, a Boolean value, or a field whose presence indicates that the first terminal device is performing the switching procedure.

In an embodiment, the second indication may be a one-bit indication, a Boolean value, or a field whose presence indicates that the second terminal device is performing the handover procedure.

According to a tenth aspect of the present disclosure, a first terminal device is provided. The first terminal device has a second terminal device serving as a relay towards a first network node or being a candidate to serve as a relay towards the first network node or a second network node. The first terminal device includes a receiving unit configured to receive a first indication from the second terminal device. The first indication indicates that the second terminal device is performing a handover procedure. The first terminal device further includes a performing unit configured to perform an operation in response to receiving the first indication.

The respective embodiments and features described above in connection with the first aspect also apply to the tenth aspect.

According to an eleventh aspect of the present disclosure, a first terminal device is provided. The first terminal device has a second terminal device serving as a relay towards a first network node or being a candidate to serve as a relay towards the first network node or a second network node. The first terminal device includes a transmitting unit configured to transmit a measurement report to the first network node. The first terminal device further includes a receiving unit configured to receive, from the first network node, an instruction to switch to a direct link with the first network node or the second network node or to a link towards the first network node or the second network node with the second terminal device as the relay. The transmitting unit is further configured to transmit a first indication to the second terminal device. The first indication indicates that the first terminal device is performing a switching procedure.

The respective embodiments and features described above in connection with the second aspect also apply to the eleventh aspect.

According to a twelfth aspect of the present disclosure, a first terminal device is provided. The first terminal device includes a transceiver, a processor and a memory. The memory contains instructions executable by the processor whereby the first terminal device is operative to perform the method according to the above first or second aspect.

According to a thirteenth aspect of the present disclosure, a computer readable storage medium is provided. The computer readable storage medium has computer program instructions stored thereon. The computer program instructions, when executed by a processor in a first terminal device, cause the first terminal device to perform the method according to the above first or second aspect.

According to a fourteenth aspect of the present disclosure, a second terminal device is provided. The second terminal device is serving as a relay for a first terminal device towards a first network node or is a candidate to serve as a relay for the first terminal device towards the first network node or a second network node. The second terminal device includes a receiving unit configured to receive a first indication from the first terminal device. The first indication indicates that the first terminal device is performing a switching procedure to switch to a direct link with the first network node or the second network node or to a link towards the first network node or the second network node with the second terminal device as the relay. The second terminal device further includes a performing unit configured to perform an operation in response to receiving the first indication.

The respective embodiments and features described above in connection with the third aspect also apply to the fourteenth aspect.

According to a fifteenth aspect of the present disclosure, a second terminal device is provided. The second terminal device is serving as a relay for a first terminal device towards a first network node or is a candidate to serve as a relay for the first terminal device towards the first network node or a second network node. The second terminal device includes a transmitting unit configured to transmit a measurement report to the first network node or the second network node. The second terminal device further includes a receiving unit configured to receive, from the first network node or the second network node, a handover command. The transmitting unit is further configured to transmit a first indication to the first terminal device. The first indication indicates that the second terminal device is performing a handover procedure.

The respective embodiments and features described above in connection with the fourth aspect also apply to the fifteenth aspect.

According to a sixteenth aspect of the present disclosure, a second terminal device is provided. The second terminal device includes a transceiver, a processor and a memory. The memory contains instructions executable by the processor whereby the second terminal device is operative to perform the method according to the above third or fourth aspect.

According to a seventeenth aspect of the present disclosure, a computer readable storage medium is provided. The computer readable storage medium has computer program instructions stored thereon. The computer program instructions, when executed by a processor in a second terminal device, cause the second terminal device to perform the method according to the above third or fourth aspect.

According to an eighteenth aspect of the present disclosure, a first network node serving a first terminal device is provided. The first terminal device has a second terminal device serving as a relay towards the first network node or being a candidate to serve as a relay towards the first network node. The first network node includes a first receiving and determining unit configured to receive a first measurement report from the first terminal device and determine based on the first measurement report that a first criterion for initiating a switching procedure for the first terminal device is fulfilled, the switching procedure being for the first terminal device to switch to a direct link with the first network node or a second network node or to a link towards the first network node with the second terminal device as the relay, and/or a second receiving and determining unit configured to receive a second measurement report from the second terminal device and determine based on the second measurement report that a second criterion for initiating a handover procedure for the second terminal device is fulfilled. The first network node further includes a performing unit configured to perform an operation in response to determining that the first criterion is fulfilled and/or determining that the second criterion is fulfilled.

The respective embodiments and features described above in connection with the fifth aspect also apply to the eighteenth aspect.

According to a nineteenth aspect of the present disclosure, a first network node serving a first terminal device is provided. The first terminal device has a second terminal device being a candidate to serve as a relay towards a second network node. The first network node includes a transmitting unit configured to transmit, to the first terminal device, an instruction or configuration to perform an operation in response to receiving an indication from the second terminal device. The indication indicates that the second terminal device is performing a handover procedure.

The respective embodiments and features described above in connection with the sixth aspect also apply to the nineteenth aspect.

According to a twentieth aspect of the present disclosure, a first network node serving a first terminal device is provided. The first terminal device has a second terminal device being a candidate to serve as a relay towards a second network node. The first network node includes a transmitting unit configured to transmit a first indication to the second network node, the first indication indicating that the first terminal device is performing a switching procedure to switch to a link towards the second network node with the second terminal device as the relay, or a receiving unit configured to receive a second indication from the second network node, the second indication indicating that the second terminal device is performing a handover procedure.

The respective embodiments and features described above in connection with the seventh aspect also apply to the twentieth aspect.

According to a twenty-first aspect of the present disclosure, a first network node is provided. The first network node includes a transceiver, a processor and a memory. The memory contains instructions executable by the processor whereby the first network node is operative to perform the method according to any of the above fifth to seventh aspects.

According to a twenty-second aspect of the present disclosure, a computer readable storage medium is provided. The computer readable storage medium has computer program instructions stored thereon. The computer program instructions, when executed by a processor in a first network node, cause the first network node to perform the method according to any of the above fifth to seventh aspects.

According to a twenty-third aspect of the present disclosure, a second network node serving a second terminal device is provided. The second terminal device is a candidate to serve as a relay for a first terminal device served by a first network node towards the second network node. The second network node includes a transmitting unit configured to transmit, to the second terminal device, an instruction or configuration to perform an operation in response to receiving an indication from the first terminal device. The indication indicates that the first terminal device is performing a switching procedure to switch to a link towards the second network node with the second terminal device as the relay.

The respective embodiments and features described above in connection with the eighth aspect also apply to the twenty-third aspect.

According to a twenty-fourth aspect of the present disclosure, a second network node serving a second terminal device is provided. The second terminal device is a candidate to serve as a relay for a first terminal device served by a first network node towards the second network node. The second network node includes a transmitting unit configured to transmit a second indication to the first network node, the second indication indicating that the second terminal device is performing a handover procedure, or a receiving unit configured to receive a first indication from the first network node, the first indication indicating that the first terminal device is performing a switching procedure to switch to a link towards the second network node with the second terminal device as the relay.

The respective embodiments and features described above in connection with the ninth aspect also apply to the twenty-fourth aspect.

According to a twenty-fifth aspect of the present disclosure, a second network node is provided. The second network node includes a transceiver, a processor and a memory. The memory contains instructions executable by the processor whereby the second network node is operative to perform the method according to the above eighth or ninth aspect.

According to a twenty-sixth aspect of the present disclosure, a computer readable storage medium is provided. The computer readable storage medium has computer program instructions stored thereon. The computer program instructions, when executed by a processor in a second network node, cause the second network node to perform the method according to the above eighth or ninth aspect.

With the embodiments of the present disclosure, various operations may be performed to prevent from a path switch procedure and a handover procedure from being initiated at the same time (e.g., at least overlapping in time), such that service continuity can be guaranteed.

### BRIEF DESCRIPTION OF THE DRAWINGS

The above and other objects, features and advantages will be more apparent from the following description of embodiments with reference to the figures, in which:

FIG. 1 is a schematic diagram showing a user plane stack for L2 UE-to-Network Relay UE;

FIG. 2 is a schematic diagram showing a control plane stack for L2 UE-to-Network Relay UE;

FIG. 3 is a schematic diagram showing a connection establishment for indirect communication via UE-to-Network Relay UE;

FIG. 4 is a schematic diagram showing a procedure for remote UE switching to direct Uu cell;

FIG. 5 is a schematic diagram showing a procedure for remote UE switching to indirect relay UE;

FIG. 6 is a schematic diagram showing a basic handover scenario where neither the AMF nor the UPF changes;

FIG. 7 is a flowchart illustrating a method in a first terminal device according to an embodiment of the present disclosure;

FIG. 8 is a flowchart illustrating a method in a first terminal device according to another embodiment of the present disclosure;

FIG. 9 is a flowchart illustrating a method in a second terminal device according to an embodiment of the present disclosure;

FIG. 10 is a flowchart illustrating a method in a second terminal device according to another embodiment of the present disclosure;

FIG. 11 is a flowchart illustrating a method in a first network node according to an embodiment of the present disclosure;

FIG. 12 is a flowchart illustrating a method in a first network node according to another embodiment of the present disclosure;

FIG. 13 is a flowchart illustrating a method in a first network node according to yet another embodiment of the present disclosure;

FIG. 14 is a flowchart illustrating a method in a second network node according to an embodiment of the present disclosure;

FIG. 15 is a flowchart illustrating a method in a second network node according to another embodiment of the present disclosure;

FIG. 16 is a block diagram of a first terminal device according to an embodiment of the present disclosure;

FIG. 17 is a block diagram of a first terminal device according to another embodiment of the present disclosure;

FIG. 18 is a block diagram of a first terminal device according to yet another embodiment of the present disclosure;

FIG. 19 is a block diagram of a second terminal device according to an embodiment of the present disclosure;

FIG. 20 is a block diagram of a second terminal device according to another embodiment of the present disclosure;

FIG. 21 is a block diagram of a second terminal device according to yet another embodiment of the present disclosure;

FIG. 22 is a block diagram of a first network node according to an embodiment of the present disclosure;

FIG. 23 is a block diagram of a first network node according to another embodiment of the present disclosure;

FIG. 24 is a block diagram of a first network node according to yet another embodiment of the present disclosure;

FIG. 25 is a block diagram of a first network node according to still another embodiment of the present disclosure;

FIG. 26 is a block diagram of a second network node according to an embodiment of the present disclosure;

FIG. 27 is a block diagram of a second network node according to another embodiment of the present disclosure;

FIG. 28 is a block diagram of a second network node according to yet another embodiment of the present disclosure;

FIG. 29 schematically illustrates a telecommunication network connected via an intermediate network to a host computer;

FIG. 30 is a generalized block diagram of a host computer communicating via a base station with a user equipment over a partially wireless connection; and

FIGS. 31 to 34 are flowcharts illustrating methods implemented in a communication system including a host computer, a base station and a user equipment.

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network node in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network node” or “network device” refers to a device in a wireless communication network via which a terminal device accesses the network and receives services therefrom. The network node or network device refers to a base station (BS), an access point (AP), or any other suitable device in the wireless communication network. The BS may be, for example, a node B (NodeB or NB), an evolved NodeB (eNodeB or eNB), or a (next) generation NodeB (gNB), a Remote Radio Unit (RRU), a radio header (RH), a remote radio head (RRH), a relay, a low power node such as a femto, a pico, and so forth. Yet further examples of the network node may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network node may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VOIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink transmission refers to a transmission from the network node to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

To enable the enhancements to NR sidelink transmissions as described above, new physical channels and reference signals are introduced in NR:
Physical Sidelink Shared Channel (PSSCH), a sidelink version of Physical Downlink Shared Channel (PDSCH): The PSSCH is transmitted by a sidelink transmitter UE, and conveys sidelink transmission data, System Information Blocks (SIBs) for Radio Resource Control (RRC) configuration, and a part of Sidelink Control Information (SCI).
PSFCH, a sidelink version of Physical Uplink Control Channel (PUCCH): The PSFCH is transmitted by a sidelink receiver UE for unicast and groupcast, and conveys 1 bit information over 1 Resource Block (RB) for a Hybrid Automatic Repeat reQuest (HARQ) acknowledgement (ACK) or negative ACK (NACK). In addition, Channel State Information (CSI) is carried in a Medium Access Control (MAC) Control Element (CE) over the PSSCH instead of the PSFCH.
PSCCH, a sidelink version of Physical Downlink Control Channel (PDCCH): When traffic to be transmitted to a receiver UE arrives at a transmitter UE, a transmitter UE should first transmit the PSCCH, which conveys a part of SCI to be decoded by any UE for the channel sensing purpose, including reserved time-frequency resources for transmissions, DeModulation Reference Signal (DMRS) pattern and antenna port, etc.
Sidelink Primary/Secondary Synchronization Signal (S-PSS/S-SSS): Similar to downlink transmissions in NR, in sidelink transmissions, S-PSS and S-SSS are supported. Through detecting the S-PSS and S-SSS, a UE is able to identify a Sidelink Synchronization Identity (SSID) from the UE transmitting the S-PSS/S-SSS. Through detecting the S-PSS/S-SSS, the UE is therefore able to know the characteristics of the transmitter UE from the S-PSS/S-SSS. A series of processes of acquiring timing and frequency synchronization together with SSIDs of UEs is called initial cell search. Note that the UE transmitting the S-PSS/S-SSS may not be necessarily involved in sidelink transmissions, and a node (e.g., UE, evolved NodeB (eNB), or (next) generation NodeB (gNB)) transmitting the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a Synchronization Signal/PSBCH Block (SSB). The SSB has the same numerology as PSCCH/PSSCH on a carrier, and an SSB should be transmitted within the bandwidth of a configured Bandwidth Part (BWP). The PSBCH conveys information related to synchronization, such as Direct Frame Number (DFN), an indication of slot and symbol level time resources for sidelink transmissions, in-coverage indicator, etc. The SSB is transmitted periodically every 160 ms.
DMRS, Phase Tracking Reference Signal (PT-RS), Channel State Information Reference Signal (CSIRS): These physical reference signals supported by NR downlink/uplink transmissions are also adopted by sidelink transmissions. Similarly, the PT-RS is only applicable for Frequency Range 2 (FR2) transmission.

Another new feature is a two-stage Sidelink Control Information (SCI). This is a version of the Downlink Control Information (DCI) for sidelink. Unlike the DCI, only part (first stage) of the SCI is sent on the PSCCH. This part is used for channel sensing purposes (including the reserved time-frequency resources for transmissions, DMRS pattern and antenna port, etc.) and can be read by all UEs, while the remaining (second stage) scheduling and control information, such as a 8-bits source IDentity (ID) and a 16-bits destination ID, a New Data Indicator (NDI), a Redundancy Version (RV), and a HARQ process ID is sent on the PSSCH to be decoded by the receiver UE.

Similar as for PROSE in LTE, NR sidelink transmissions have the following two modes of resource allocations:
Mode 1: Sidelink resources are scheduled by a gNB.
Mode 2: The UE autonomously selects sidelink resources from one or more (pre)configured sidelink resource pools based on a channel sensing mechanism.

For an in-coverage UE, a gNB can be configured to adopt Mode 1 or Mode 2. For an out-of-coverage UE, only Mode 2 can be adopted.

As in LTE, scheduling over the sidelink in NR is done in different ways for Mode 1 and Mode 2.

Mode 1 supports the following two types of grants:
Dynamic grant: When traffic to be transmitted over sidelink arrives at a transmitter UE, the UE should initiate a four-message exchange procedure to request sidelink resources from a gNB (Scheduling Request (SR) on Uplink (UL), grant, Buffer Status Report (BSR) on UL, grant for data on Sidelink (SL) transmitted to UE). During a resource request procedure, the gNB may allocate a Sidelink Radio Network Temporary Identifier (SL-RNTI) to the transmitter UE. If this sidelink resource request is granted by the gNB, then the gNB indicates the resource allocation for the PSCCH and the PSSCH in the DCI conveyed by PDCCH with Cyclic Redundancy Check (CRC) scrambled with the SL-RNTI. When the transmitter UE receives such DCI, the transmitter UE can obtain the grant only if the scrambled CRC of DCI can be successfully solved by the assigned SL-RNTI. The transmitter UE then indicates time-frequency resources and transmission scheme of the allocated PSSCH in the PSCCH, and transmits the PSCCH and the PSSCH on the allocated resources for sidelink transmissions. When the grant is obtained from the gNB, the transmitter UE can only transmit a single Transport Block (TB). As a result, this type of grant is suitable for traffic with a loose latency requirement.
Configured grant: For traffic with a strict latency requirement, performing the four-message exchange procedure to request sidelink resources may induce unacceptable latency. In this case, before traffic arrives, a transmitter UE may perform the four-message exchange procedure and request a set of resources. If a grant can be obtained from a gNB, then the requested resources are reserved in a periodic manner. When the traffic arrives at the transmitter UE, the UE can transmit the PSCCH and the PSSCH on an upcoming resource occasion. In fact, this type of grant is also known as grant-free transmissions.

In both dynamic grant and configured grant, a sidelink receiver UE cannot receive the DCI (since it is addressed to the transmitter UE), and therefore the receiver UE should perform blind decoding to identify the presence of PSCCH and find the resources for the PSSCH based on the SCI.

When the transmitter UE transmits the PSCCH, CRC is also inserted in the SCI without any scrambling.

In Mode 2, when traffic arrives at a transmitter UE, the transmitter UE should autonomously select resources for the PSCCH and the PSSCH. To further minimize the latency of the feedback HARQ ACK/NACK transmissions and subsequently retransmissions, the transmitter UE may also reserve resources for PSCCH/PSSCH for retransmissions. To further enhance the probability of successful TB decoding at one shot and thus suppress the probability to perform retransmissions, the transmitter UE may repeat the TB transmission in addition to the initial TB transmission. This mechanism is also known as blind retransmission. As a result, when traffic arrives at the transmitter UE, the transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore provided for Mode 2 based on channel sensing algorithm. The channel sensing algorithm involves measuring Reference Signal Received Power (RSRP) on different subchannels and requires knowledge of the different UEs' power levels of the DMRS on the PSSCH or the DMRS on the PSCCH depending on a configuration. This information is known only after receiving the SCI transmitted by (all) other UEs. The sensing and selection algorithm is rather complex.

Device-to-Device (D2D) discovery procedures are provided for detection of services and applications offered by other UEs in close proximity. This is a part of LTE Release 12 and Release 13. The discovery procedure has two modes, Mode A based on open announcements (broadcasts) and Mode B based on request/response. The discovery procedure is controlled by the application layer (e.g., ProSe layer). In NR, a discovery message is transmitted on the PSSCH. The discovery procedure can be used to detect UEs supporting certain services or applications before initiating the communication. Both dedicated discovery resource pool (i.e., only discovery messages can be transmitted in the pool) and shared resource pool (i.e., both discovery messages and other data and control messages can be transmitted in the pool) are supported in NR. Whether dedicated discovery resource pool is configured is dependent on network implementation.

FIG. 1 shows a user plane protocol stack for an L2 UE-to-Network Relay UE, related to a Protocol Data Unit (PDU) Session. The PDU layer corresponds to the PDU carried between the Remote UE and the Data Network (DN) over the PDU session. It is important to note that two endpoints of a Packet Data Convergence Protocol (PDCP) link are the Remote UE and the gNB. A relay function is performed below PDCP. This means that data security is ensured between the Remote UE and the gNB without exposing raw data at the L2 UE-to-Network Relay UE.

The adaptation rely layer within the user plane stack for the L2 UE-to-Network Relay UE can differentiate between Signaling Radio Bearers (SRBs) and Data Radio Bearers (DRBs) for a particular Remote UE. The adaption relay layer is also responsible for mapping PC5 traffic to one or more DRBs of the Uu. The definition of the adaptation relay layer is under the responsibility of RAN Work Group 2 (WG2).

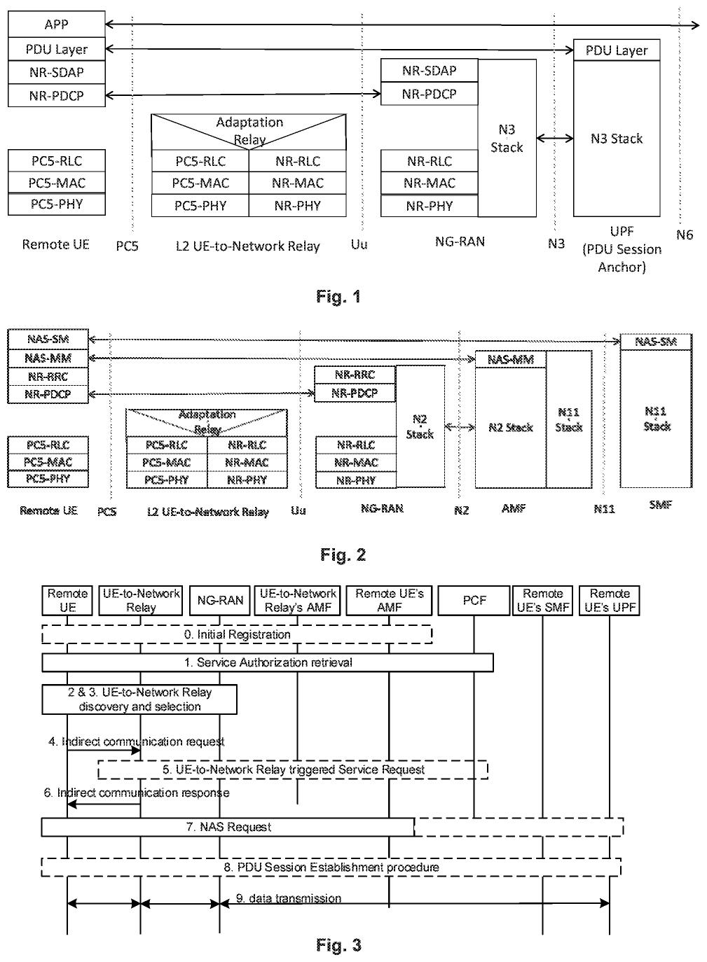

FIG. 2 shows a control plane protocol stack for an L2 UE-to-Network Relay UE, which illustrates a Non-Access Stratum (NAS) connection for a Remote UE to NAS Mobility Management (NAS-MM) and NAS Management (NAS-SM) components. The NAS messages are transparently transferred between the Remote UE and 5G Access Network (5G-AN) over the L2 UE-to-Network Relay UE using:
PDCP end-to-end connection where the role of the L2 UE-to-Network Relay UE is to relay PDUs over an SRB without any modifications.
N2 connection between the 5G-AN and Access and Mobility Management Function (AMF) over N2.
N3 connection between the AMF and Session Management Function (SMF) over N11.

The role of the L2 UE-to-Network Relay UE is to relay the PDUs from the SRB without any modifications.

FIG. 3 shows a procedure of connection establishment for indirect communication via a UE-to-Network Relay UE. The procedure includes the following steps (for further details, reference can be made to TR 23.752):

Step 0: If in coverage, the Remote UE and UE-to-Network Relay UE may independently perform Initial Registration to the network according to registration procedures in 3GPP Technical Specification (TS) 23.502, V16.7.1. An allocated 5G Globally Unique Temporary UE Identity (GUTI) of the Remote UE is maintained when later NAS signalling between Remote UE and Network is exchanged via the UE-to-Network Relay UE.

Step 1: If in coverage, the Remote UE and UE-to-Network Relay UE independently get the Service Authorization for indirect communication from the network.

Steps 2 and 3: The Remote UE and UE-to-Network Relay UE perform UE-to-Network Relay UE discovery and selection.

Step 4: Remote UE initiates a one-to-one communication connection with the selected UE-to-Network Relay UE over PC5, by sending an indirect communication request message to the UE-to-Network Relay.

Step 5: If the UE-to-Network Relay UE is in Connection Management (CM)_IDLE state, triggered by the communication request received from the Remote UE, the UE-to-Network Relay UE sends a Service Request message over PC5 to its serving AMF.

The Relay's AMF may perform authentication of the UE-to-Network Relay UE based on NAS message validation and if needed the AMF will check the subscription data.

If the UE-to-Network Relay UE is already in CM_CONNECTED state and is authorised to perform Relay service then Step 5 is omitted.

Step 6: The UE-to-Network Relay UE sends the indirect communication response message to the Remote UE.

Step 7: Remote UE sends a NAS message to the serving AMF. The NAS message is encapsulated in an RRC message that is sent over PC5 to the UE-to-Network Relay UE, and the UE-to-Network Relay UE forwards the message to the NG-RAN. The NG-RAN derives Remote UE's serving AMF and forwards the NAS message to this AMF.

Step 8: Remote UE may trigger the PDU Session Establishment procedure as defined in clause 4.3.2.2 of TS 23.502.

Step 9: The data is transmitted between Remote UE and User Plane Function (UPF) via UE-to-Network Relay UE and NG-RAN. The UE-to-Network Relay UE forwards all the data messages between the Remote UE and NG-RAN using RAN specified L2 relay method.

As described in clause 4.5.4 of 3GPP TR 38.836 V1.0.0, which is incorporated herein for reference in its entirety, an L2 UE-to-Network Relay uses the RAN2 principle of the Release15 NR handover procedure as the baseline Access Stratum (AS) layer solution to guarantee service continuity. For example, a gNB may switch a remote UE to a target cell or target relay UE, including:
1) Handover preparation type of procedure between the gNB and a relay UE (if needed),
2) RRCReconfiguration to the remote UE, the remote UE switching to the target cell or target relay UE, and
3) Handover complete message, similar to the legacy procedure.

Exact content of the messages (e.g., handover command) can be discussed in the Work Item (WI) phase. This does not imply that inter-node messages will be transmitted over Uu.

In the following, the common parts of intra-gNB cases and inter-gNB cases are captured. For the inter-gNB cases, compared to the intra-gNB cases, potential different parts on RAN2 Uu interface in details can be studied either in the Study Item (SI) phase or in the WI phase.

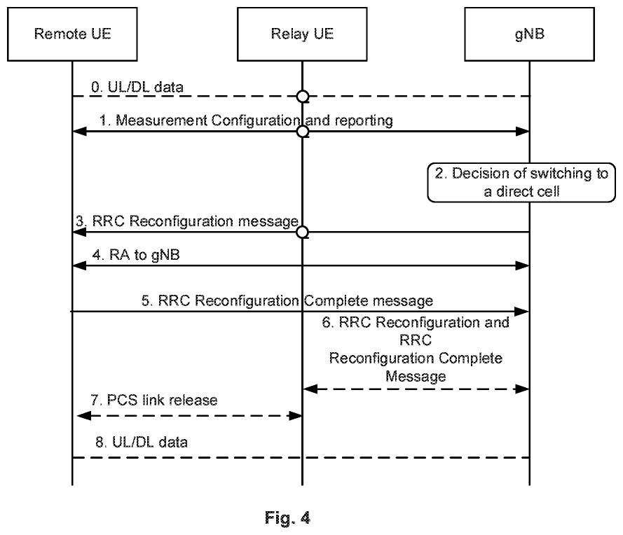

FIG. 4 shows a procedure for a remote UE switching from indirect relay UE to direct Uu cell. For service continuity of L2 UE-to-Network relay, the baseline procedure including the following steps is used, in case of the remote UE switching to direct Uu cell:

Step 1: Measurement configuration and reporting

Step 2: Decision of switching to a direct cell by gNB

Step 3: RRC Reconfiguration message to remote UE

Step 4: Remote UE performs Random Access to the gNB

Step 5: Remote UE feedback the RRCReconfigurationComplete to gNB via target path, using the target configuration provided in the RRC Reconfiguration message.

Step 6: RRC Reconfiguration to relay UE

Step 7: The PC5 link is released between remote UE and the relay UE, if needed.

Step 8: The data path switching.

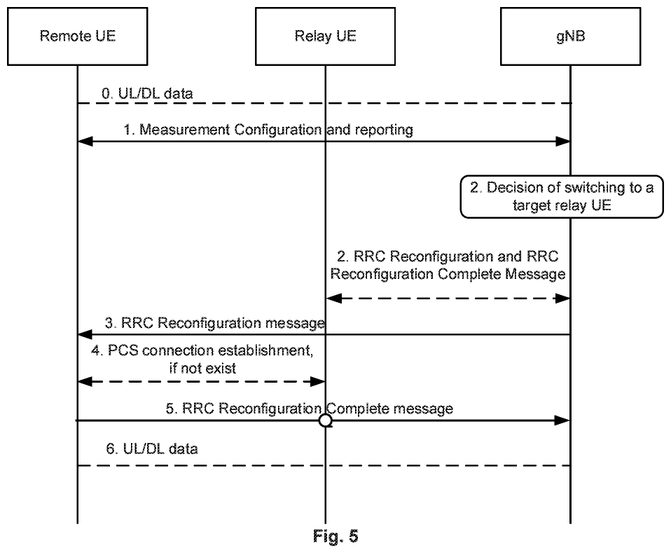

FIG. 5 shows a procedure for a remote UE switching from direct Uu cell to indirect relay UE. For service continuity of L2 UE-to-Network relay, the baseline procedure including the following steps is used, in case of remote UE switching to indirect relay UE:

Step 1: Remote UE reports one or multiple candidate relay UE(s), after remote UE measures/discoveries the candidate relay UE(s).
Remote UE may filter one or more appropriate relay UEs meeting higher layer criteria when reporting, in Step 1.
The reporting may include the relay UE's ID and SL RSRP information, where the measurement on PC5 details can be left to WI phase, in Step 1.

Step 2: Decision of switching to a target relay UE by gNB, and target (re)configuration is sent to relay UE optionally (like preparation).

Step 3: RRC Reconfiguration message to remote UE. Following information may be included: 1) Identity of the target relay UE; 2) Target Uu and PC5 configuration.

Step 4: Remote UE establishes PC5 connection with target relay UE, if the connection has not been setup yet.

Step 5: Remote UE feedback the RRCReconfigurationComplete to gNB via target path, using the target configuration provided in RRCReconfiguration.

Step 6: The data path switching.

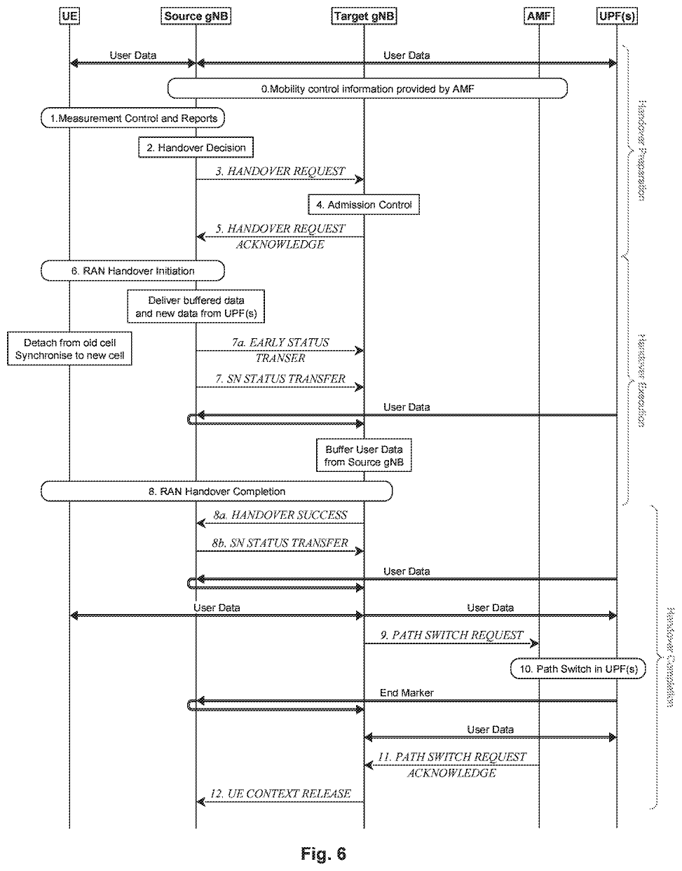

FIG. 6 shows a handover procedure. The intra-NR RAN handover performs the preparation and execution phase of the handover procedure performed without involvement of the 5G Core Network (5GC), i.e. preparation messages are directly exchanged between the gNBs. The release of the resources at the source gNB during the handover completion phase is triggered by the target gNB. In the basic handover scenario shown in FIG. 6, neither the AMF nor the UPF changes. The basic handover includes the following steps (for further details, reference can be made to TS 38.300):

Step 0: UE context within the source gNB contains information regarding roaming and access restrictions which were provided either at connection establishment or at the last Tracking Area (TA) update.

Step 1: The source gNB configures the UE measurement procedures and the UE reports according to the measurement configuration.

Step 2: The source gNB decides to handover the UE, based on MeasurementReport and Radio Resource Management (RRM) information.

Step 3: The source gNB issues a Handover Request message to the target gNB passing a transparent RRC container with necessary information to prepare the handover at the target side. The information includes at least the target cell ID, KgNB*, Cell Radio Network Temporary Identifier (C-RNTI) of the UE in the source gNB, RRM-configuration including UE inactive time, basic AS-configuration including antenna Information and Downlink (DL) Carrier Frequency, the current QoS flow to DRB mapping rules applied to the UE, the SIB1 from source gNB, the UE capabilities for different Radio Access Technologies (RATs), PDU session related information, and can include the UE reported measurement information including beam-related information if available. The PDU session related information includes slice information and QoS flow level QoS profile(s). The source gNB may also request a Dual Active Protocol Stack (DAPS) handover for one or more DRBs.

Step 4: Admission Control may be performed by the target gNB. Slice-aware admission control shall be performed if the slice information is sent to the target gNB. If the PDU sessions are associated with non-supported slices the target gNB shall reject such PDU Sessions.

Step 5: The target gNB prepares the handover with L1/L2 and sends the HANDOVER REQUEST ACKNOWLEDGE to the source gNB, which includes a transparent container to be sent to the UE as an RRC message to perform the handover. The target gNB also indicates if a DAPS handover is accepted.

Step 6: The source gNB triggers the Uu handover by sending an RRCReconfiguration message to the UE, containing the information required to access the target cell: at least the target cell ID, the new C-RNTI, the target gNB security algorithm identifiers for the selected security algorithms. It can also include a set of dedicated Random Access CHannel (RACH) resources, the association between RACH resources and SSB(s), the association between RACH resources and UE-specific Channel State Information Reference Signal (CSI-RS) configuration(s), common RACH resources, and system information of the target cell, etc.

Step 7a: For DRBs configured with DAPS, the source gNB sends the EARLY STATUS TRANSFER message. The DL COUNT value conveyed in the EARLY STATUS TRANSFER message indicates Packet Data Convergence Protocol (PDCP) Sequence Number (SN) and HyperFrame Number (HFN) of the first PDCP Service Data Unit (SDU) that the source gNB forwards to the target gNB. The source gNB does not stop assigning SNs to downlink PDCP SDUs until it sends the SN STATUS TRANSFER message to the target gNB in Step 8b.

Step 7: For DRBs not configured with DAPS, the source gNB sends the SN STATUS TRANSFER message to the target gNB to convey the uplink PDCP SN receiver status and the downlink PDCP SN transmitter status of DRBs for which PDCP status preservation applies (i.e. for Radio Link Control (RLC) Acknowledge Mode (AM)). The uplink PDCP SN receiver status includes at least the PDCP SN of the first missing UL PDCP SDU and may include a bit map of the receive status of the out of sequence UL PDCP SDUs that the UE needs to retransmit in the target cell, if any. The downlink PDCP SN transmitter status indicates the next PDCP SN that the target gNB shall assign to new PDCP SDUs, not having a PDCP SN yet.

Step 8: The UE synchronises to the target cell and completes the RRC handover procedure by sending RRCReconfigurationComplete message to target gNB. In case of DAPS handover, the UE does not detach from the source cell upon receiving the RRCReconfiguration message. The UE releases the source resources and configurations and stops DL/UL reception/transmission with the source upon receiving an explicit release from the target node.

Step 8a/8b: In case of DAPS handover, the target gNB sends the HANDOVER SUCCESS message to the source gNB to inform that the UE has successfully accessed the target cell. In return, the source gNB sends the SN STATUS TRANSFER message for DRBs configured with DAPS for which the description in Step 7 applies, and the normal data forwarding follows as defined in 9.2.3.2.3.

Step 9: The target gNB sends a PATH SWITCH REQUEST message to AMF to trigger 5GC to switch the DL data path towards the target gNB and to establish an NG-C interface instance towards the target gNB.

Step 10: 5GC switches the DL data path towards the target gNB. The UPF sends one or more “end marker” packets on the old path to the source gNB per PDU session/tunnel and then can release any U-plane/Transport Network Layer (TNL) resources towards the source gNB.

Step 11: The AMF confirms the PATH SWITCH REQUEST message with the PATH SWITCH REQUEST ACKNOWLEDGE message.

Step 12: Upon reception of the PATH SWITCH REQUEST ACKNOWLEDGE message from the AMF, the target gNB sends the UE CONTEXT RELEASE to inform the source gNB about the success of the handover. The source gNB can then release radio and C-plane related resources associated to the UE context. Any ongoing data forwarding may continue.

The RRM configuration can include both beam measurement information (for layer 3 mobility) associated to SSB(s) and CSI-RS(s) for the reported cell(s) if both types of measurements are available. Also, if Channel Assignment (CA) is configured, the RRM configuration can include a list of best cells on each frequency for which measurement information is available. The RRM measurement information can also include the beam measurement for the listed cells that belong to the target gNB.

The common RACH configuration for beams in the target cell is only associated to the SSB(s). The network can have dedicated RACH configurations associated to the SSB(s) and/or have dedicated RACH configurations associated to CSI-RS(s) within a cell. The target gNB can only include one of the following RACH configurations in the Handover Command to enable the UE to access the target cell:
i) Common RACH configuration;
ii) Common RACH configuration+Dedicated RACH configuration associated with SSB;
iii) Common RACH configuration+Dedicated RACH configuration associated with CSI-RS.

The dedicated RACH configuration allocates RACH resource(s) together with a quality threshold to use them. When dedicated RACH resources are provided, they are prioritized by the UE and the UE shall not switch to contention-based RACH resources as long as the quality threshold of those dedicated resources is met. The order to access the dedicated RACH resources is up to UE implementation.

Upon receiving a handover command requesting DAPS handover, the UE suspends source cell SRBs, stops sending and receiving any RRC control plane signaling toward the source cell, and establishes SRBs for the target cell. The UE releases the source cell SRBs configuration upon receiving source cell release indication from the target cell after successful DAPS handover execution. When DAPS handover to the target cell fails and if the source cell link is available, then the UE reverts back to the source cell configuration and resumes source cell SRBs for control plane signaling transmission.

The following embodiments will be described mainly in the context of NR, i.e., a remote UE and a relay UE are deployed in a same NR cell or different NR cells. The embodiments are also applicable to other relay scenarios where the remote UE and the relay UE may be based on LTE sidelink or NR sidelink, and the Uu connection between the relay UE and a network node may be LTE Uu or NR Uu.

Here, the term “direct connection”, “direct path”, or “direct link” as used herein refers to a connection between a UE and a gNB, while terms “indirect connection”, “indirect path”, or “indirect link” refers to a connection between a remote UE and a gNB via a relay UE. In addition, the term “path switch” as used herein means that a remote UE changes from a direct path (i.e., Uu connection) to an indirect path or vice versa, or changes from one indirect path to another indirect path (e.g., from one relay UE to another relay UE), with or without change of serving cell or serving gNB. The term “relay selection/reselection” is equally applicable here. On the other hand, the term “handover” refers to change of serving cell or serving gNB.

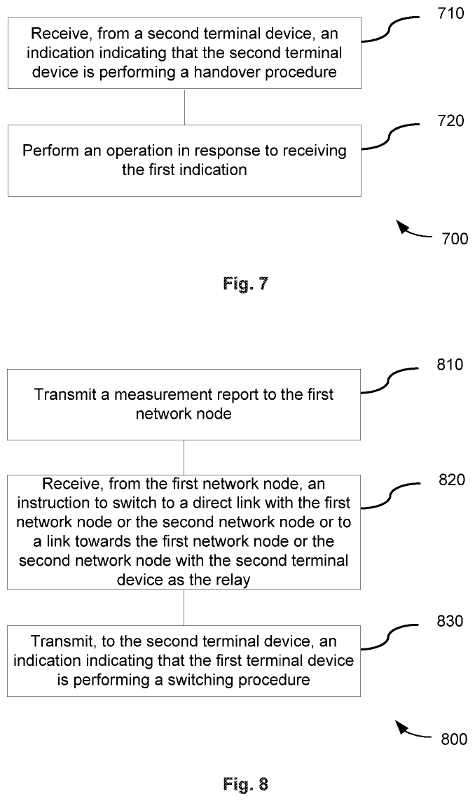

FIG. 7 is a flowchart illustrating a method 700 according to an embodiment of the present disclosure. The method 700 can be performed at a first terminal device. The first terminal device has a second terminal device serving as a relay towards a first network node or being a candidate to serve as a relay towards the first network node or a second network node.

Here, the first network node may be e.g., a serving gNB of the first terminal device. The first terminal device may be e.g., a UE having a direct link with the first network node, or a remote UE having an indirect link towards the first network node with a serving relay UE between the remote UE and the first network node. The second terminal device may be the serving relay UE (in which case the first network node is also the serving gNB of the second terminal device). The second terminal device may alternatively be a candidate relay UE for the first terminal device towards the first network node (in which case the first network node is also the serving gNB of the second terminal device) or the second network node (in which case the second network node is also the serving gNB of the second terminal device).

At block 710, an indication (referred to as handover indication hereinafter) is received from the second terminal device, and the handover indication indicates that the second terminal device is performing a handover procedure (e.g., an inter-gNB handover procedure).

In an example, the handover indication may be a one-bit indication, e.g., with a value of “1” indicating that the second terminal device is performing the handover procedure and “0” indicating that the second terminal device is not performing the handover procedure. Alternatively, the handover indication may be a Boolean value, e.g., with a value of “true” indicating that the second terminal device is performing the handover procedure and “false” indicating that the second terminal device is not performing the handover procedure. Alternatively, the handover indication may be a field whose presence indicates that the second terminal device is performing the handover procedure and whose absence indicates that the second terminal device is not performing the handover procedure.

At block 720, an operation is performed in response to receiving the handover indication.

In an example, in the block 720, in response to receiving the handover indication, when a triggering criterion for transmitting a measurement report of the first terminal device is fulfilled, the first terminal device may delay transmission of the measurement report to the first network node.

In an example, the measurement report of the first terminal device may include one or more of: a first link measurement between the first terminal device and the first network node, a second link measurement between the first terminal device and the second network node, a third link measurement between the first terminal device and the second terminal device, and a fourth link measurement between the first terminal device and a third terminal device (which may be a serving relay UE of the first terminal device when the second terminal device is a candidate relay UE of the first terminal device).

In an example, the transmission of the measurement report may be delayed by a predetermined time length. For example, a timer may be provided at the first terminal device. The timer may be started upon receiving the handover indication from the second terminal device, and the measurement report may be transmitted only after the timer expires. The timer may be configured by the first network node or hard coded in a specification.

In an example, in the block 720, in response to receiving the handover indication, the first terminal device may delay the transmission of the measurement report until an indication (referred to as handover complete indication) indicating that the handover procedure is completed is received from the second terminal device or the first network node.

In an example, in the block 720, in response to receiving the handover indication, when the triggering criterion for transmitting the measurement report is fulfilled, the first terminal device may transmit the measurement report to the first network node. The measurement report may contain the handover indication. In this case, after transmitting the measurement report containing the handover indication, the first terminal device may simply follow the first network node's instruction to perform path switch without interfering with the handover procedure.

In an example, in the block 720, in response to receiving the handover indication, when the triggering criterion for transmitting the measurement report is fulfilled, the first terminal device may initiate a cell reselection, relay discovery, or relay reselection procedure, or enter an RRC_IDLE or RRC_INACTIVE state, without transmitting the measurement report to the first network node. For example, the first terminal device may initiate the cell reselection procedure in order to establish a new Uu connection towards a new serving cell, without having to wait for completion of the handover procedure. In such case, the PC5 link between the first terminal device and its serving relay UE, if any, may or may not be maintained. Alternatively, the first terminal device may initiate the relay discovery or relay reselection procedure to establish a new PC5 link with a new relay UE. In another example, the first terminal device may release the PC5 link between the first terminal device and its serving relay UE and go to RRC_IDLE/RRC_INACTIVE. Then, the first terminal device will eventually reselect a new gNB or a new relay UE, perform RRC connection reestablishment, and transit to RRC_CONNECTED again.

In an example, in the block 720, in response to receiving the handover indication, the first terminal device may change the triggering criterion for transmitting the measurement report to be more difficult to be fulfilled, e.g., such that the measurement report will be transmitted later compared with a measurement report triggered based on a legacy triggering criterion. For example, the triggering criterion may include at least one of a threshold, an offset, and a hypothesis used in a measurement event.

In an example, e.g., when the second terminal device is the candidate to serve as the relay, in the block 720, in response to receiving the handover indication, when the triggering criterion for transmitting the measurement report is fulfilled, the first terminal device may transmit the measurement report to the first network node. The measurement report may include one or more of: the first link measurement between the first terminal device and the first network node and/or the second link measurement between the first terminal device and the second network node and/or the fourth link measurement between the first terminal device and the third terminal device, as described above, and exclude the third link measurement between the first terminal device and the second terminal device. In this case, the first terminal device will not be instructed by the first network node to switch to an indirect link with the second terminal device as the relay.

In an example, the first terminal device may receive, from the first network node or another control device, an instruction or configuration to perform the operation in response to receiving the handover indication. That is, which of the above options the first terminal device is to use may be dependent on the instruction or configuration. Alternatively, which of the above options the first terminal device is to use may be preconfigured, e.g., hard coded in a specification.

In an example, the handover indication may be received directly from the second terminal device, e.g., when the second terminal device is the serving relay for the first terminal device, or forwarded by a third terminal device, which may be a serving relay UE of the first terminal device when the second terminal device is a candidate relay UE of the first terminal device, using RRC signaling (e.g., PC5-RRC), PC5-S, discovery signaling, MAC CE, L1 signaling (e.g., on a channel such as Physical Random Access Channel (PRACH), PUCCH, or PDCCH), or control PDU of a protocol layer (e.g., Service Data Adaptation Protocol (SDAP), PDCP, RLC or an adaptation layer introduced for responsible of duplication function). It is to be noted that all signaling between terminal devices, as described above or below, can be transmitted/received in the same or similar way.

Alternatively, the handover indication may be forwarded by the first network node, using RRC signaling, MAC CE, L1 signaling (e.g., on channels such as PSSCH, PSCCH, or PSFCH), or control PDU of a protocol layer (e.g., SDAP, PDCP, RLC or an adaptation layer introduced for responsible of duplication function). It is to be noted that all signaling between any terminal device and any network node, as described above or below, can be transmitted/received in the same or similar way.

FIG. 8 is a flowchart illustrating a method 800 according to an embodiment of the present disclosure. The method 800 can be performed at a first terminal device.

The first terminal device has a second terminal device serving as a relay towards a first network node or being a candidate to serve as a relay towards the first network node or a second network node.

Here, the first network node may be e.g., a serving gNB of the first terminal device. The first terminal device may be e.g., a UE having a direct link with the first network node, or a remote UE having an indirect link towards the first network node with a serving relay UE between the remote UE and the first network node. The second terminal device may be the serving relay UE (in which case the first network node is also the serving gNB of the second terminal device). The second terminal device may alternatively be a candidate relay UE for the first terminal device towards the first network node (in which case the first network node is also the serving gNB of the second terminal device) or the second network node (in which case the second network node is also the serving gNB of the second terminal device).

At block 810, a measurement report of the first terminal device is transmitted to the first network node.

In an example, the measurement report may include one or more of the followings: a first link measurement between the first terminal device and the first network node, a second link measurement between the first terminal device and the second network node, a third link measurement between the first terminal device and the second terminal device, and a fourth link measurement between the first terminal device and a third terminal device (which may be a serving relay UE of the first terminal device when the second terminal device is a candidate relay UE of the first terminal device).

At block 820, an instruction (referred to as path switch instruction, e.g., RRC Reconfiguration) is received from the first network node. The instruction is used to instruct the first terminal device to switch to a direct link with the first network node or the second network node or to a link towards the first network node or the second network node with the second terminal device as the relay.

At block 830, an indication (referred to as path switch indication hereinafter) is transmitted to the second terminal device. The path switch indication indicates that the first terminal device is performing a switching (path switch) procedure.

In an example, the path switch indication may be a one-bit indication, e.g., with a value of “1” indicating that the first terminal device is performing the switching procedure and “0” indicating that the first terminal device is not performing the switching procedure. Alternatively, the path switch indication may be a Boolean value, e.g., with a value of “true” indicating that the first terminal device is performing the switching procedure and “false” indicating that the first terminal device is not performing the switching procedure. Alternatively, the path switch indication may be a field whose presence indicates that the first terminal device is performing the switching procedure and whose absence indicates that the first terminal device is not performing the switching procedure.

In an example, the first terminal device may receive an indication (handover indication) from the second terminal device. The handover indication indicating that the second terminal device is performing a handover procedure. When the second terminal device is serving as the relay, in response to receiving the handover indication, the first terminal device may abort the switching procedure and initiate link reestablishment. Alternatively, when the second terminal device is the candidate to serve as the relay, in response to receiving the handover indication, the first terminal device may notify the first network node that the second terminal device is performing the handover procedure and/or that the second terminal device is no longer available as the candidate. Accordingly, the first network node may direct the first terminal device to switch to another path (e.g., a direct path or an indirect path).

In an example, the path switch indication may be directly transmitted to the second terminal device, e.g., when the second terminal device is the serving relay for the first terminal device, or may be transmitted to a third terminal device (which may be a serving relay UE of the first terminal device when the second terminal device is a candidate relay UE of the first terminal device) for forwarding to the second terminal device, using RRC signaling (e.g., PC5-RRC), PC5-S, discovery signaling, MAC CE, L1 signaling (e.g., on a channel such as PRACH, PUCCH, or PDCCH), or control PDU of a protocol layer (e.g., SDAP, PDCP, RLC or an adaptation layer introduced for responsible of duplication function).

Alternatively, the path switch indication may be transmitted to the first network node for forwarding towards the second terminal device, using RRC signaling. MAC CE, L1 signaling (e.g., on channels such as PSSCH, PSCCH, or PSFCH), or control PDU of a protocol layer (e.g., SDAP, PDCP, RLC or an adaptation layer introduced for responsible of duplication function).

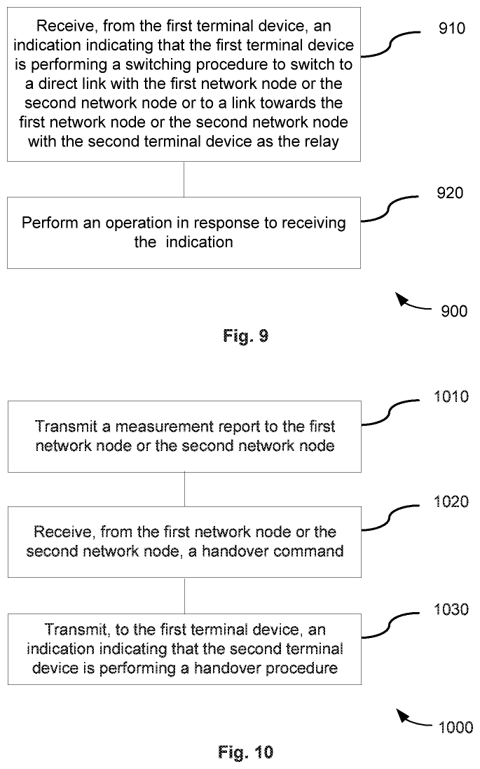

FIG. 9 is a flowchart illustrating a method 900 according to an embodiment of the present disclosure. The method 900 can be performed at a second terminal device. The second terminal device is serving as a relay for a first terminal device towards a first network node or is a candidate to serve as a relay for the first terminal device towards the first network node or a second network node.

Here, the first network node may be e.g., a serving gNB of the first terminal device. The first terminal device may be e.g., a UE having a direct link with the first network node, or a remote UE having an indirect link towards the first network node with a serving relay UE between the remote UE and the first network node. The second terminal device may be the serving relay UE (in which case the first network node is also the serving gNB of the second terminal device). The second terminal device may alternatively be a candidate relay UE for the first terminal device towards the first network node (in which case the first network node is also the serving gNB of the second terminal device) or the second network node (in which case the second network node is also the serving gNB of the second terminal device).

At block 910, an indication (referred to as path switch indication hereinafter) is received from the first terminal device. The path switch indication indicates that the first terminal device is performing a switching (path switch) procedure to switch to a direct link with the first network node or the second network node or to a link towards the first network node or the second network node with the second terminal device as the relay.

In an example, the path switch indication may be a one-bit indication, e.g., with a value of “1” indicating that the first terminal device is performing the switching procedure and “0” indicating that the first terminal device is not performing the switching procedure. Alternatively, the path switch indication may be a Boolean value, e.g., with a value of “true” indicating that the first terminal device is performing the switching procedure and “false” indicating that the first terminal device is not performing the switching procedure. Alternatively, the path switch indication may be a field whose presence indicates that the first terminal device is performing the switching procedure and whose absence indicates that the first terminal device is not performing the switching procedure.

At block 920, an operation is performed in response to receiving the path switch indication.

In an example, in the block 920, in response to receiving the path switch indication, when a triggering criterion for transmitting a measurement report of the second terminal device is fulfilled, the second terminal device may delay transmission of the measurement report to the first network node or the second network node.

In an embodiment, the measurement report of the second terminal device may include one or more of: a first link measurement between the second terminal device and the first network node or second network node, and a second link measurement between the second terminal device and a third network node.

In an example, the transmission of the measurement report may be delayed by a predetermined time length. For example, a timer may be provided at the second terminal device. The timer may be started upon receiving the path switch indication from the first terminal device, and the measurement report may be transmitted only after the timer expires. The timer may be configured by the first or second network node, or hard coded in a specification.

In an example, in the block 920, in response to receiving the path switch indication, the second terminal device may delay the transmission of the measurement report until an indication (referred to as path switch complete indication) indicating that the switching procedure is completed is received from the first terminal device or the first network node or the second network node.

In an example, in the block 920, in response to receiving the path switch indication, when the triggering criterion for transmitting the measurement report is fulfilled, the second terminal device may transmit the measurement report to the first network node or second network node. The measurement report may contain the path switch indication. In this case, after transmitting the measurement report containing the path switch indication, the second terminal device may simply follow the first or second network node's instruction to perform handover without interfering with the switching procedure.

In an example, in the block 920, in response to receiving the path switch indication, when the triggering criterion for transmitting the measurement report is fulfilled, the second terminal device may transmit the measurement report to the first network node or the second network node and receive, from the first network node or the second network node, a handover command. Then, the second terminal device may transmit, to the first terminal device, an indication (handover indication) indicating that the second terminal device is performing a handover procedure, and/or trigger release of a link between the first terminal device and the second terminal device (if any). This may happen when the second terminal device has latency-sensitive (e.g., Ultra-Reliable Low Latency Communication (URLLC)) traffic and the first network node or second network node and/or the second terminal device does not want to prioritize the path switch procedure over the handover procedure.

In an example, subsequent to transmitting the handover indication to the first terminal device, the second terminal device may transmit, to the first network node or the second network node for forwarding to the first network node, an indication indicating that the handover indication has been transmitted to the first terminal device, in order to facilitate the first network node to take actions to avoid collision between the switching procedure and the handover procedure.

In an example, in the block 920, in response to receiving the path switch indication, the second terminal device may change the triggering criterion for transmitting the measurement report to be more difficult to be fulfilled, e.g., such that the measurement report will be transmitted later compared with a measurement report triggered based on a legacy triggering criterion. For example, the triggering criterion may include at least one of a threshold, an offset, and a hypothesis used in a measurement event.

In an example, in the block 920, in response to receiving the path switch indication, when the triggering criterion for transmitting the measurement report is fulfilled, the second terminal device may initiate a cell reselection, without transmitting the measurement report to the first network node or second network node. For example, when the second terminal device is a candidate relay UE, the cell reselection may allow the second terminal device to establish a new Uu connection towards a new serving cell, which is faster than the handover procedure. In this case, the interruption time will be shorter when the first terminal device performs path switch to the candidate relay UE.

In an example, the second terminal device may receive, from the first network node, the second network node, or another control device, an instruction or configuration to perform the operation in response to receiving the path switch indication. That is, which of the above options the second terminal device is to use may be dependent on the instruction or configuration. Alternatively, which of the above options the second terminal device is to use may be preconfigured, e.g., hard coded in a specification.

In an example, the path switch indication may be received directly from the first terminal device, e.g., when the second terminal device is the serving relay for the first terminal device, using RRC signaling (e.g., PC5-RRC), PC5-S, discovery signaling, MAC CE, L1 signaling (e.g., on a channel such as PRACH, PUCCH, or PDCCH), or control PDU of a protocol layer (e.g., SDAP, PDCP, RLC or an adaptation layer introduced for responsible of duplication function).

In an example, the path switch indication may be forwarded by the first network node or the second network node using RRC signaling, MAC CE, L1 signaling (e.g., on channels such as PSSCH, PSCCH, or PSFCH), or control PDU of a protocol layer (e.g., SDAP, PDCP, RLC or an adaptation layer introduced for responsible of duplication function).

FIG. 10 is a flowchart illustrating a method 1000 according to an embodiment of the present disclosure. The method 1000 can be performed at the second terminal device. The second terminal device is serving as a relay for a first terminal device towards a first network node or is a candidate to serve as a relay for the first terminal device towards the first network node or a second network node.

Here, the first network node may be e.g., a serving gNB of the first terminal device. The first terminal device may be e.g., a UE having a direct link with the first network node, or a remote UE having an indirect link towards the first network node with a serving relay UE between the remote UE and the first network node. The second terminal device may be the serving relay UE (in which case the first network node is also the serving gNB of the second terminal device). The second terminal device may alternatively be a candidate relay UE for the first terminal device towards the first network node (in which case the first network node is also the serving gNB of the second terminal device) or the second network node (in which case the second network node is also the serving gNB of the second terminal device).

At block 1010, a measurement report of the second terminal device is transmitted to the first network node or the second network node.

At block 1020, a handover command is received from the first network node or the second network node.

At block 1030, an indication (handover indication) is transmitted to the first terminal device. The handover indication indicates that the second terminal device is performing a handover procedure.

In an example, the handover indication may be a one-bit indication, e.g., with a value of “1” indicating that the second terminal device is performing the handover procedure and “0” indicating that the second terminal device is not performing the handover procedure. Alternatively, the handover indication may be a Boolean value, e.g., with a value of “true” indicating that the second terminal device is performing the handover procedure and “false” indicating that the second terminal device is not performing the handover procedure. Alternatively, the handover indication may be a field whose presence indicates that the second terminal device is performing the handover procedure and whose absence indicates that the second terminal device is not performing the handover procedure.

In an example, the measurement report may include one or more of: a first link measurement between the second terminal device and the first network node or second network node, and a second link measurement between the second terminal device and a third network node.

In an example, the handover indication may be directly transmitted to the first terminal device e.g., when the second terminal device is the serving relay for the first terminal device, using RRC signaling (e.g., PC5-RRC), PC5-S, discovery signaling, MAC CE, L1 signaling (e.g., on a channel such as PRACH, PUCCH, or PDCCH), or control PDU of a protocol layer (e.g., SDAP, PDCP, RLC or an adaptation layer introduced for responsible of duplication function).

Alternatively, the handover indication may be transmitted to the first network node or the second network node for forwarding towards the first terminal device, using RRC signaling, MAC CE, L1 signaling (e.g., on channels such as PSSCH, PSCCH, or PSFCH), or control PDU of a protocol layer (e.g., SDAP, PDCP, RLC or an adaptation layer introduced for responsible of duplication function).

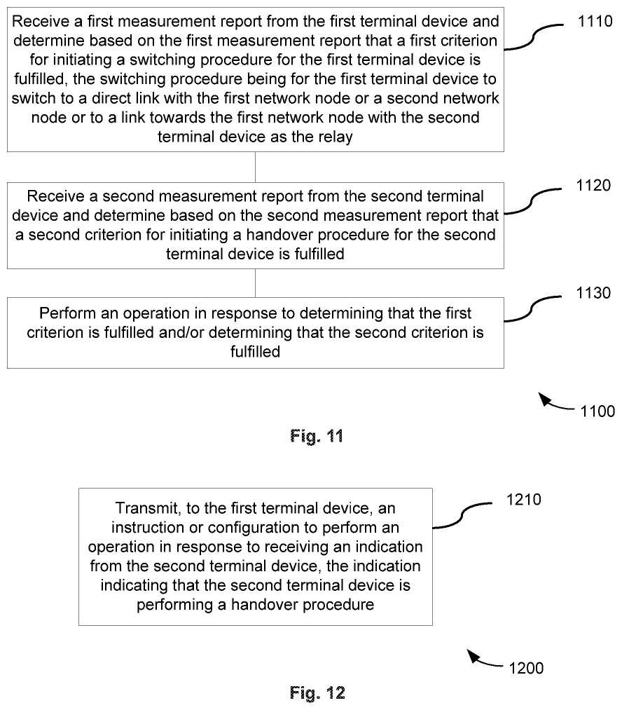

FIG. 11 is a flowchart illustrating a method 1100 according to an embodiment of the present disclosure. The method 1100 can be performed at a first network node. The first network node is serving a first terminal device, and the first terminal device has a second terminal device serving as a relay towards the first network node or being a candidate to serve as a relay towards the first network node.

Here, the first terminal device may be e.g., a UE having a direct link with the first network node, or a remote UE having an indirect link towards the first network node with a serving relay UE between the remote UE and the first network node. The second terminal device may be the serving relay UE. The second terminal device may alternatively be a candidate relay UE for the first terminal device towards the first network node. In either case the first network node is also the serving gNB of the second terminal device.

At block 1110, the first network node receives a first measurement report from the first terminal device and determines based on the first measurement report that a first criterion for initiating a switching (path switch) procedure for the first terminal device is fulfilled. The switching procedure is for the first terminal device to switch to a direct link with the first network node or a second network node or to a link towards the first network node with the second terminal device as the relay.

At block 1120, the first network node receives a second measurement report from the second terminal device and determines based on the second measurement report that a second criterion for initiating a handover procedure (e.g., inter-gNB handover procedure) for the second terminal device is fulfilled.

At block 1130, the first network node performs an operation in response to determining that the first criterion is fulfilled and/or determining that the second criterion is fulfilled.

In an example, in the block 1130, the first network node may transmit, to the first terminal device in response to determining that the second criterion is fulfilled, an indication (referred to as first measurement report prohibited indication) indicating that transmission of the first measurement report is prohibited. Alternatively, in the block 1130, the first network node may transmit, to the second terminal device in response to determining that the first criterion is fulfilled, an indication (referred to as second measurement report prohibited indication) indicating that transmission of the second measurement report is prohibited.

In an example, when the handover procedure is completed, the first network node may transmit, to the first terminal device, an indication (referred to as first measurement report allowed indication) indicating that transmission of the first measurement report is allowed. Alternatively, when the switching procedure is completed, the first network node may transmit, to the second terminal device, an indication (referred to as second measurement report allowed indication) indicating that transmission of the second measurement report is allowed.

In an example, the first measurement report allowed indication may contain an identifier of a third network node to which the second terminal device has been handed over. In an example, the second measurement report allowed indication may further indicate whether the first terminal device has switched to the direct link with the first network node or the second network node or to a link towards the first network node with the second terminal device as the relay.

In an example, in the block 1130, in response to determining that the first criterion is fulfilled and determining that the second criterion is fulfilled (i.e., when both criteria are fulfilled), the first network node may transmit an instruction (path switch instruction, e.g., RRC Reconfiguration) to perform the switching procedure to the first terminal device, and transmit an instruction (handover instruction, e.g., handover command) to perform the handover procedure to the second terminal device after the switching procedure is completed.

Alternatively, in the block 1130, in response to determining that the first criterion is fulfilled and determining that the second criterion is fulfilled (i.e., when both criteria are fulfilled), the first network node may transmit the handover instruction to the second terminal device, and transmit the path switch instruction to the first terminal device after the handover procedure is completed.

For example, the path switch instruction may be transmitted before the handover instruction when the first measurement report is received before the second measurement report. Alternatively, the handover instruction may be transmitted before the path switch instruction when the second measurement report is received before the first measurement report.

In an example, the path switch instruction may be transmitted before the handover instruction when the switching procedure has a higher priority than the handover procedure. Alternatively, the handover instruction may be transmitted before the handover instruction when the handover procedure has a higher priority than the switching procedure. For example, the priority of the switching procedure may be dependent on a signal strength or quality of a serving link of the first terminal device, an LCH priority of a radio bearer on which the serving link of the first terminal device is operating, or a first fixed priority. Here, the serving link of the first terminal device may be a Uu link between the first terminal device and the first network node or a PC5 link between the first terminal device and the second terminal device. In addition, the priority of the handover procedure may be dependent on a signal strength or quality of a serving link of the second terminal device, an LCH priority of a radio bearer on which the serving link of the second terminal device is operating, or a second fixed priority. Here, the serving link of the second terminal device may be a Uu link between the second terminal device and the first network node. In an example, the first fixed priority and/or the second fixed priority may be configured by a RAN, a core network, or a mobile operator.

In an example, when the second terminal device is serving as the relay, in the block 1130, in response to determining that the first criterion is fulfilled and determining that the second criterion is fulfilled (i.e., when both criteria are fulfilled), the first network node may transmit, an instruction (handover instruction, e.g., handover command) to perform the handover procedure to the second terminal device and release a link between the first terminal device and the second terminal device.

In an example, in the block 1130, in response to determining that the first criterion is fulfilled and determining that the second criterion is fulfilled (i.e., when both criteria are fulfilled), the first network node may configure the first terminal device and/or the second terminal device to enter an RRC_IDLE or RRC_INACTIVE state (or any combination of these states).

In an example, the first measurement report may include one or more of: a first link measurement between the first terminal device and the first network node, a second link measurement between the first terminal device and the second network node, a third link measurement between the first terminal device and the second terminal device, and a fourth link measurement between the first terminal device and a third terminal device. The second measurement report may include one or more of: a fifth link measurement between the second terminal device and the first network node, and a sixth link measurement between the second terminal device and a third network node.

In an example, the first measurement report may be received directly from the first terminal device or forwarded by the second terminal device, and/or the second measurement report may be received directly from the second terminal device, using RRC signaling, MAC CE, L1 signaling (e.g., on channels such as PSSCH, PSCCH, or PSFCH), or control PDU of a protocol layer (e.g., SDAP, PDCP, RLC or an adaptation layer introduced for responsible of duplication function).

FIG. 12 is a flowchart illustrating a method 1200 according to an embodiment of the present disclosure. The method 1200 can be performed at a first network node. The first network node is serving a first terminal device, and the first terminal device has a second terminal device being a candidate to serve as a relay towards a second network node.

Here, the first terminal device may be e.g., a UE having a direct link with the first network node, or a remote UE having an indirect link towards the first network node with a serving relay UE between the remote UE and the first network node. The second network node may be the serving gNB of the second terminal device.

At block 1210, the first network node transmits, to the first terminal device, an instruction or configuration to perform an operation in response to receiving an indication (handover indication) from the second terminal device. The handover indication may indicate that the second terminal device is performing a handover procedure.

In an example, the operation may include: delaying, when a triggering criterion for transmitting the measurement report is fulfilled, transmission of the measurement report to the first network node as described above. Alternatively, the operation may include: initiating, when a triggering criterion for transmitting a measurement report is fulfilled, a cell reselection, relay discovery, or relay reselection procedure, or entering an RRC_IDLE or RRC_INACTIVE state, without transmitting the measurement report to the first network node. Alternatively, the operation may include: changing a triggering criterion for transmitting a measurement report to be more difficult to be fulfilled. Alternatively, the operation may include: transmitting, when the second terminal device is the candidate to serve as the relay and when a triggering criterion for transmitting a measurement report is fulfilled, a measurement report to the first network node, the measurement report including a first link measurement between the first terminal device and the first network node and/or a second link measurement between the first terminal device and the second network node and/or a fourth link measurement between the first terminal device and a third terminal device, and excluding a third link measurement between the first terminal device and the second terminal device.

In an example, the instruction or configuration may be transmitted using RRC signaling, MAC CE, L1 signaling (e.g., on channels such as PSSCH, PSCCH, or PSFCH), or control PDU of a protocol layer (e.g., SDAP, PDCP, RLC or an adaptation layer introduced for responsible of duplication function). The handover indication may be forwarded by the second network node using X2/X1 signaling, F1 signaling, or inter-node RRC message.

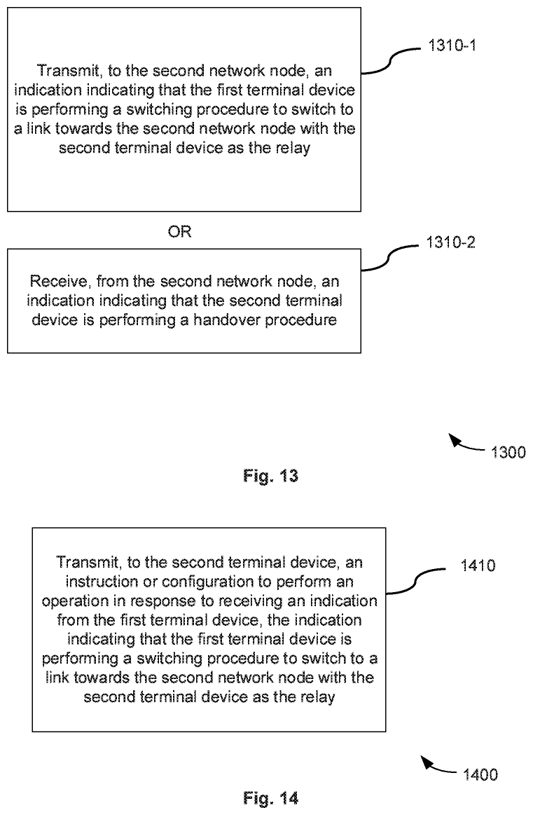

FIG. 13 is a flowchart illustrating a method 1300 according to an embodiment of the present disclosure. The method 1300 can be performed at a first network node. The first network node is serving a first terminal device, and the first terminal device has a second terminal device being a candidate to serve as a relay towards a second network node.

Here, the first terminal device may be e.g., a UE having a direct link with the first network node, or a remote UE having an indirect link towards the first network node with a serving relay UE between the remote UE and the first network node. The second terminal device may be a candidate relay UE for the first terminal device towards the second network node, and the second network node may be the serving gNB of the second terminal device.

At block 1310-1, the first network node transmits, to the second network node, an indication (path switch indication) indicating that the first terminal device is performing a switching (path switch) procedure to switch to a link towards the second network node with the second terminal device as the relay. Alternatively, at block 1310-2, the first network node receives, from the second network node, an indication (handover indication) indicating that the second terminal device is performing a handover (e.g., inter-gNB handover) procedure.

In an example, in response to receiving the handover indication, the first network node may forward the handover indication to the first terminal device, or transmit, to the first terminal device, an indication (first measurement report prohibited indication) indicating that transmission of the first measurement report is prohibited. Further, the first network node may receive, from the second network node, an indication (handover complete indication) indicating that the handover procedure is completed, and forward the handover complete indication to the first terminal device, or transmit, to the first terminal device, an indication (first measurement report allowed indication) indicating that transmission of the first measurement report is allowed.

In an example, the path switch indication may be transmitted and/or the handover indication may be received, using X2/X1 signaling, F1 signaling, or inter-node RRC message.

In an example, the path switch indication may be a one-bit indication, e.g., with a value of “1” indicating that the first terminal device is performing the switching procedure and “0” indicating that the first terminal device is not performing the switching procedure. Alternatively, the path switch indication may be a Boolean value, e.g., with a value of “true” indicating that the first terminal device is performing the switching procedure and “false” indicating that the first terminal device is not performing the switching procedure. Alternatively, the path switch indication may be a field whose presence indicates that the first terminal device is performing the switching procedure and whose absence indicates that the first terminal device is not performing the switching procedure.

In an example, the handover indication may be a one-bit indication, e.g., with a value of “1” indicating that the second terminal device is performing the handover procedure and “0” indicating that the second terminal device is not performing the handover procedure. Alternatively, the handover indication may be a Boolean value, e.g., with a value of “true” indicating that the second terminal device is performing the handover procedure and “false” indicating that the second terminal device is not performing the handover procedure. Alternatively, the handover indication may be a field whose presence indicates that the second terminal device is performing the handover procedure and whose absence indicates that the second terminal device is not performing the handover procedure.

FIG. 14 is a flowchart illustrating a method 1400 according to an embodiment of the present disclosure. The method 1400 can be performed at a second network node. The second network node is serving a second terminal device, and the second terminal device is a candidate to serve as a relay for a first terminal device served by a first network node towards the second network node.

Here, the first terminal device may be e.g., a UE having a direct link with the first network node, or a remote UE having an indirect link towards the first network node with a serving relay UE between the remote UE and the first network node.

At block 1410, the second network node transmits, to the second terminal device, an instruction or configuration to perform an operation in response to receiving an indication (path switch indication) from the first terminal device. The path switch indication indicates that the first terminal device is performing a switching procedure to switch to a link towards the second network node with the second terminal device as the relay.

In an example, the operation may include: delaying, when a triggering criterion for transmitting a measurement report is fulfilled, transmission of the measurement report to the second network node. Alternatively, the operation may include: transmitting, when a triggering criterion for transmitting a measurement report is fulfilled, the measurement report to the second network node, the measurement report containing an indication indicating that the first terminal device is performing the switching procedure. Alternatively, the operation may include: when a triggering criterion for transmitting a measurement report is fulfilled, transmitting the measurement report to the second network node, receiving, from the second network node, a handover command; and transmitting, to the first network node for forwarding to the first terminal device, an indication indicating that the second terminal device is performing a handover procedure. Alternatively, the operation may include: changing a triggering criterion for transmitting a measurement report to be more difficult to be fulfilled. Alternatively, the operation may include: initiating, when a triggering criterion for transmitting a measurement report is fulfilled, a cell reselection, without transmitting the measurement report to the second network node.

In an example, the instruction or configuration may be transmitted using RRC signaling, MAC CE, L1 signaling (e.g., on channels such as PSSCH, PSCCH, or PSFCH), or control PDU of a protocol layer (e.g., SDAP, PDCP, RLC or an adaptation layer introduced for responsible of duplication function). The path switch indication may be forwarded by the second network node using X2/X1 signaling, F1 signaling, or inter-node RRC message.

FIG. 15 is a flowchart illustrating a method 1500 according to an embodiment of the present disclosure. The method 1500 can be performed at a second network node. The second network node is serving a second terminal device, and the second terminal device is a candidate to serve as a relay for a first terminal device served by a first network node towards the second network node.

Here, the first terminal device may be e.g., a UE having a direct link with the first network node, or a remote UE having an indirect link towards the first network node with a serving relay UE between the remote UE and the first network node.

At block 1510-1, the second network node transmits, to the first network node, an indication (handover) indicating that the second terminal device is performing a handover (e.g., inter-gNB handover) procedure. Alternatively, at block 1510-2, the second network node receives, from the first network node, an indication (path switch indication) indicating that the first terminal device is performing a switching (path switch) procedure to switch to a link towards the second network node with the second terminal device as the relay.

In an example, in response to receiving the path switch indication, the second network node may forward the path switch indication to the second terminal device, or transmit, to the second terminal device, an indication (second measurement report prohibited indication) indicating that transmission of the second measurement report is prohibited. Further, the second network node may receive, from the first network node, an indication (path switch complete indication) indicating that the switching procedure is completed, and, forward the path switch complete indication to the second terminal device, or transmit, to the second terminal device, an indication (second measurement report allowed indication) indicating that transmission of the second measurement report is allowed.

In an example, the handover indication may be transmitted and/or the path switch indication may be received, using X2/X1 signaling, F1 signaling, or inter-node RRC message.

In an example, the path switch indication may be a one-bit indication, e.g., with a value of “1” indicating that the first terminal device is performing the switching procedure and “0” indicating that the first terminal device is not performing the switching procedure. Alternatively, the path switch indication may be a Boolean value, e.g., with a value of “true” indicating that the first terminal device is performing the switching procedure and “false” indicating that the first terminal device is not performing the switching procedure. Alternatively, the path switch indication may be a field whose presence indicates that the first terminal device is performing the switching procedure and whose absence indicates that the first terminal device is not performing the switching procedure.

In an example, the handover indication may be a one-bit indication, e.g., with a value of “1” indicating that the second terminal device is performing the handover procedure and “0” indicating that the second terminal device is not performing the handover procedure. Alternatively, the handover indication may be a Boolean value, e.g., with a value of “true” indicating that the second terminal device is performing the handover procedure and “false” indicating that the second terminal device is not performing the handover procedure. Alternatively, the handover indication may be a field whose presence indicates that the second terminal device is performing the handover procedure and whose absence indicates that the second terminal device is not performing the handover procedure.

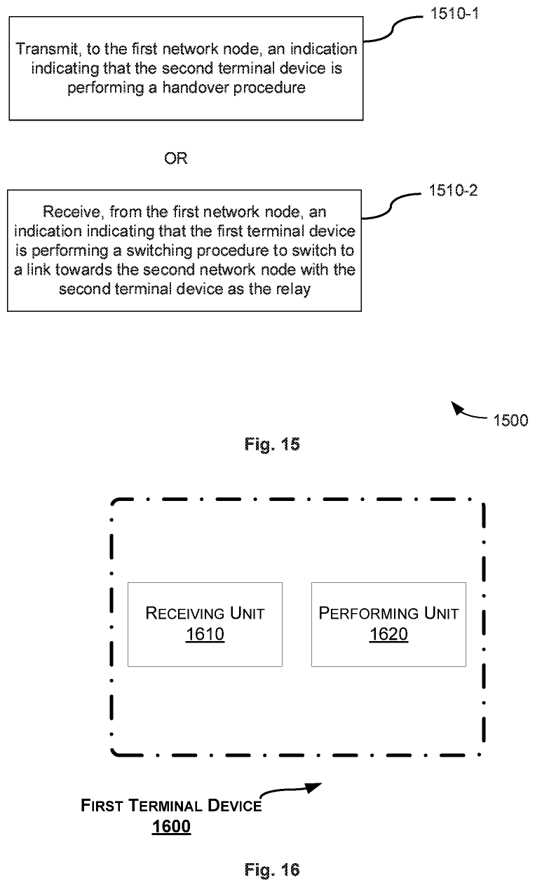

Correspondingly to the method 700 as described above, a first terminal device is provided. FIG. 16 is a block diagram of a first terminal device 1600 according to an embodiment of the present disclosure.

The first terminal device has a second terminal device serving as a relay towards a first network node or being a candidate to serve as a relay towards the first network node or a second network node.

As shown in FIG. 16, the first terminal device 1600 includes a receiving unit 1610 configured to receive a first indication from a second terminal device. The first indication indicates that the second terminal device is performing a handover procedure. The first terminal device 1600 further includes a performing unit 1620 configured to perform an operation in response to receiving the first indication.

In an embodiment, the operation may include: delaying, when a triggering criterion for transmitting a measurement report is fulfilled, transmission of the measurement report to the first network node.

In an embodiment, the operation of delaying may include: delaying the transmission of the measurement report by a predetermined time length.

In an embodiment, the operation of delaying may include: delaying the transmission of the measurement report until a second indication indicating that the handover procedure is completed is received from the second terminal device or the first network node.

In an embodiment, the operation may include: transmitting, when a triggering criterion for transmitting a measurement report is fulfilled, the measurement report to the first network node. The measurement report contains the first indication indicating that the second terminal device is performing the handover procedure.

In an embodiment, the operation may include, when a triggering criterion for transmitting a measurement report is fulfilled: initiating a cell reselection, relay discovery, or relay reselection procedure, or entering an RRC_IDLE or RRC_INACTIVE state, without transmitting the measurement report to the first network node.

In an embodiment, the operation may include: changing a triggering criterion for transmitting a measurement report to be more difficult to be fulfilled.

In an embodiment, the triggering criterion may include at least one of a threshold, an offset, and a hypothesis.

In an embodiment, the measurement report may include one or more of: a first link measurement between the first terminal device and the first network node, a second link measurement between the first terminal device and the second network node, a third link measurement between the first terminal device and the second terminal device, and a fourth link measurement between the first terminal device and a third terminal device.

In an embodiment, the operation may include, when the second terminal device is the candidate to serve as the relay: transmitting, when a triggering criterion for transmitting a measurement report is fulfilled, a measurement report to the first network node. The measurement report includes a first link measurement between the first terminal device and the first network node and/or a second link measurement between the first terminal device and the second network node and/or a fourth link measurement between the first terminal device and a third terminal device, and excludes a third link measurement between the first terminal device and the second terminal device.

In an embodiment, the receiving unit 1610 may be configured to receive, from the first network node or another control device, an instruction or configuration to perform the operation in response to receiving the first indication.

In an embodiment, the first indication may be received directly from the second terminal device, or may be forwarded by a third terminal device, using: RRC signaling,

PC5-S, discovery signaling, MAC CE, L1 signaling, or control PDU of a protocol layer.

In an embodiment, the first indication may be forwarded by the first network node using: RRC signaling, MAC CE, L1 signaling, or control PDU of a protocol layer.

In an embodiment, the first indication may be a one-bit indication, a Boolean value, or a field whose presence indicates that the second terminal device is performing the handover procedure.

The receiving unit 1610 and the performing unit 1620 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions of the embodiments described above, and illustrated, e.g., in FIG. 7.

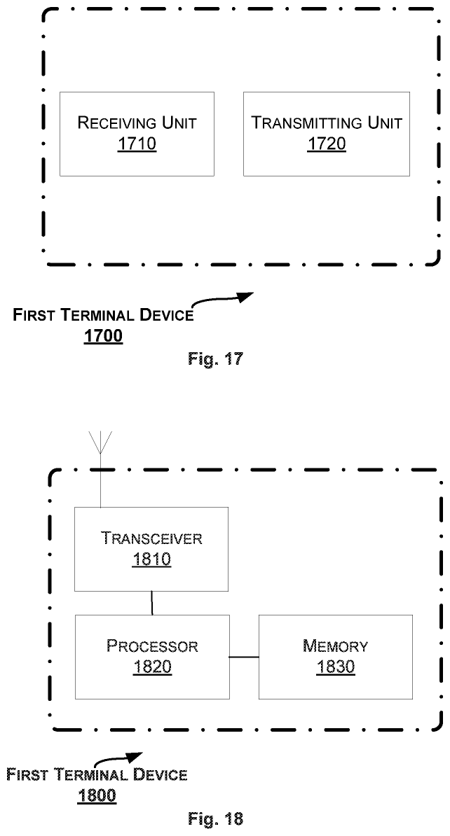

Correspondingly to the method 800 as described above, a first terminal device is provided. FIG. 17 is a block diagram of a first terminal device 1700 according to an embodiment of the present disclosure.

The first terminal device has the second terminal device serving as a relay towards a first network node or being a candidate to serve as a relay towards the first network node or the second network node.

As shown in FIG. 17, the first terminal device 1700 includes a receiving unit 1710 configured to receive, from the first network node, an instruction to switch to a direct link with the first network node or the second network node or to a link towards the first network node or the second network node with the second terminal device as the relay. The first terminal device 1700 further includes a transmitting unit 1720 configured to: transmit a measurement report to the first network node, and transmit a first indication to the second terminal device. The first indication indicates that the first terminal device is performing a switching procedure.

In an embodiment, the receiving unit 1710 may be configured to: receive a second indication from the second terminal device. The second indication indicates that the second terminal device is performing a handover procedure. The first terminal device 1700 may further include an aborting unit configured to: abort, when the second terminal device is serving as the relay, the switching procedure and initiating link reestablishment. Alternatively, the first terminal device 1700 may further include a notifying unit configured to: notify, when the second terminal device is the candidate to serve as the relay, the first network node that the second terminal device is performing the handover procedure and/or that the second terminal device is no longer available as the candidate.

In an embodiment, the measurement report may include one or more of: a first link measurement between the first terminal device and the first network node, a second link measurement between the first terminal device and the second network node, a third link measurement between the first terminal device and the second terminal device, and a fourth link measurement between the first terminal device and a third terminal device.

In an embodiment, the first indication may be directly transmitted to the second terminal device, or may be transmitted to a third terminal device for forwarding to the second terminal device, using: RRC signaling, PC5-S, discovery signaling, MAC CE, L1 signaling, or control PDU of a protocol layer.

In an embodiment, the first indication may be transmitted to the first network node for forwarding towards the second terminal device, using: RRC signaling, MAC CE, L1 signaling, or control PDU of a protocol layer.

In an embodiment, the first indication may be a one-bit indication, a Boolean value, or a field whose presence indicates that the first terminal device is performing the switching procedure.

The receiving unit 1710 and the transmitting unit 1720 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8.

FIG. 18 is a block diagram of a first terminal device 1800 according to another embodiment of the present disclosure.

The first terminal device has a second terminal device serving as a relay towards a first network node or being a candidate to serve as a relay towards the first network node or a second network node.

The first terminal device 1800 includes a transceiver 1810, a processor 1820 and a memory 1830. The memory 1830 may contain instructions executable by the processor 1820 whereby the first terminal device 1800 is operative to perform the actions, e.g., of the procedure described earlier in conjunction with FIG. 7.

Particularly, the memory 1830 contains instructions executable by the processor 1820 whereby the first terminal device 1800 is operative to: receive a first indication from a second terminal device, the first indication indicating that the second terminal device is performing a handover procedure; and perform an operation in response to receiving the first indication.

In an embodiment, the operation may include: delaying, when a triggering criterion for transmitting a measurement report is fulfilled, transmission of the measurement report to the first network node.

In an embodiment, the operation of delaying may include: delaying the transmission of the measurement report by a predetermined time length.

In an embodiment, the operation of delaying may include: delaying the transmission of the measurement report until a second indication indicating that the handover procedure is completed is received from the second terminal device or the first network node.

In an embodiment, the operation may include: transmitting, when a triggering criterion for transmitting a measurement report is fulfilled, the measurement report to the first network node. The measurement report contains the first indication indicating that the second terminal device is performing the handover procedure.

In an embodiment, the operation may include, when a triggering criterion for transmitting a measurement report is fulfilled: initiating a cell reselection, relay discovery, or relay reselection procedure, or entering an RRC_IDLE or RRC_INACTIVE state, without transmitting the measurement report to the first network node.

In an embodiment, the operation may include: changing a triggering criterion for transmitting a measurement report to be more difficult to be fulfilled.

In an embodiment, the triggering criterion may include at least one of a threshold, an offset, and a hypothesis.

In an embodiment, the measurement report may include one or more of: a first link measurement between the first terminal device and the first network node, a second link measurement between the first terminal device and the second network node, a third link measurement between the first terminal device and the second terminal device, and a fourth link measurement between the first terminal device and a third terminal device.

In an embodiment, the operation may include, when the second terminal device is the candidate to serve as the relay: transmitting, when a triggering criterion for transmitting a measurement report is fulfilled, a measurement report to the first network node. The measurement report includes a first link measurement between the first terminal device and the first network node and/or a second link measurement between the first terminal device and the second network node and/or a fourth link measurement between the first terminal device and a third terminal device, and excludes a third link measurement between the first terminal device and the second terminal device.

In an embodiment, the memory 1830 may further contain instructions executable by the processor 1820 whereby the first terminal device 1800 is operative to: receive, from the first network node or another control device, an instruction or configuration to perform the operation in response to receiving the first indication.

In an embodiment, the first indication may be received directly from the second terminal device, or may be forwarded by a third terminal device, using: RRC signaling, PC5-S, discovery signaling, MAC CE, L1 signaling, or control PDU of a protocol layer.

In an embodiment, the first indication may be forwarded by the first network node using: RRC signaling, MAC CE, L1 signaling, or control PDU of a protocol layer.

In an embodiment, the first indication may be a one-bit indication, a Boolean value, or a field whose presence indicates that the second terminal device is performing the handover procedure.

Alternatively, the memory 1830 may contain instructions executable by the processor 1820 whereby the first terminal device 1800 is operative to perform the actions, e.g., of the procedure described earlier in conjunction with FIG. 8. Particularly, the memory 1830 contains instructions executable by the processor 1820 whereby the first terminal device 1800 is operative to: transmit a measurement report to a first network node; receive, from the first network node, an instruction to switch to a direct link with the first network node or a second network node or to a link towards the first network node or the second network node with a second terminal device as the relay; and transmit a first indication to the second terminal device, the first indication indicating that the first terminal device is performing a switching procedure.

In an embodiment, the memory 1830 may further contain instructions executable by the processor 1820 whereby the first terminal device 1800 is operative to: receive a second indication from the second terminal device, the second indication indicating that the second terminal device is performing a handover procedure; and abort, when the second terminal device is serving as the relay, the switching procedure and initiating link reestablishment; or notify, when the second terminal device is the candidate to serve as the relay, the first network node that the second terminal device is performing the handover procedure and/or that the second terminal device is no longer available as the candidate.

In an embodiment, the measurement report may include one or more of: a first link measurement between the first terminal device and the first network node, a second link measurement between the first terminal device and the second network node, a third link measurement between the first terminal device and the second terminal device, and a fourth link measurement between the first terminal device and a third terminal device.

In an embodiment, the first indication may be directly transmitted to the second terminal device, or may be transmitted to a third terminal device for forwarding to the second terminal device, using: RRC signaling, PC5-S, discovery signaling, MAC CE, L1 signaling, or control PDU of a protocol layer.

In an embodiment, the first indication may be transmitted to the first network node for forwarding towards the second terminal device, using: RRC signaling, MAC CE, L1 signaling, or control PDU of a protocol layer.

In an embodiment, the first indication may be a one-bit indication, a Boolean value, or a field whose presence indicates that the first terminal device is performing the switching procedure.

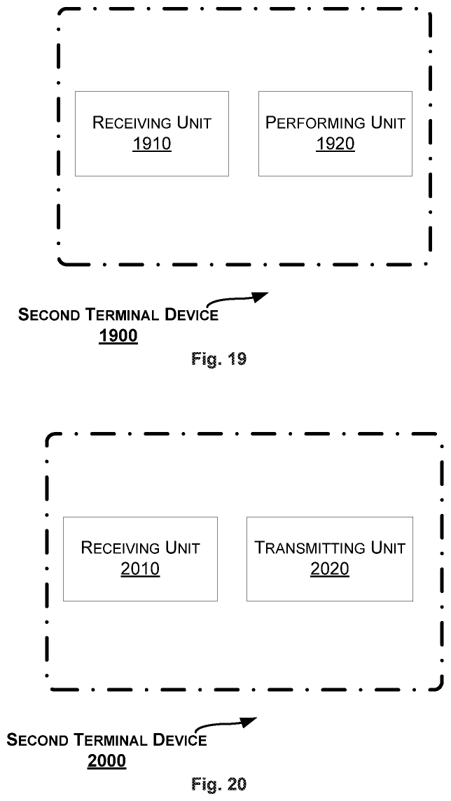

Correspondingly to the method 900 as described above, a second terminal device is provided. FIG. 19 is a block diagram of a second terminal device 1900 according to an embodiment of the present disclosure.

The second terminal device is serving as a relay for a first terminal device towards a first network node or is a candidate to serve as a relay for the first terminal device towards the first network node or a second network node.

As shown in FIG. 19, the second terminal device 1900 includes a receiving unit 1910 configured to receive a first indication from the first terminal device. The first indication indicates that the first terminal device is performing a switching procedure to switch to a direct link with the first network node or the second network node or to a link towards the first network node or the second network node with the second terminal device as the relay. The second terminal device 1900 further includes a performing unit 1920 configured to perform an operation in response to receiving the first indication.

In an embodiment, the operation may include: delaying, when a triggering criterion for transmitting a measurement report is fulfilled, transmission of the measurement report to the first network node or the second network node.

In an embodiment, the operation of delaying may include: delaying the transmission of the measurement report by a predetermined time length.

In an embodiment, the operation of delaying may include: delaying the transmission of the measurement report until a second indication indicating that the switching procedure is completed is received from the first terminal device or the first network node or the second network node.

In an embodiment, the operation may include: transmitting, when a triggering criterion for transmitting a measurement report is fulfilled, the measurement report to the first network node or the second network node. The measurement report contains the first indication indicating that the first terminal device is performing the switching procedure.

In an embodiment, the operation may include, when a triggering criterion for transmitting a measurement report is fulfilled: transmitting the measurement report to the first network node or the second network node; receiving, from the first network node or the second network node, a handover command; and transmitting, to the first terminal device, a third indication indicating that the second terminal device is performing a handover procedure, and/or triggering release of a link between the first terminal device and the second terminal device.

In an embodiment, the operation may further include, subsequent to transmitting the third indication: transmitting, to the first network node, a fourth indication indicating that the third indication has been transmitted to the first terminal device.

In an embodiment, the operation may include: changing a triggering criterion for transmitting a measurement report to be more difficult to be fulfilled.

In an embodiment, the triggering criterion may include at least one of a threshold, an offset, and a hypothesis.

In an embodiment, the operation may include, when a triggering criterion for transmitting a measurement report is fulfilled: initiating a cell reselection, without transmitting the measurement report to the first network node or the second network node.

In an embodiment, the measurement report may include one or more of: a first link measurement between the second terminal device and the first or second network node, and a second link measurement between the second terminal device and a third network node.

In an embodiment, the receiving unit 1910 may be configured to: receive, from the first network node, the second network node, or another control device, an instruction or configuration to perform the operation in response to receiving the first indication.

In an embodiment, the first indication may be received directly from the first terminal device, using: RRC signaling, PC5-S, discovery signaling, MAC CE, L1 signaling, or control PDU of a protocol layer.

In an embodiment, the first indication may be forwarded by the first network node or the second network node, using: RRC signaling, MAC CE, L1 signaling, or control PDU of a protocol layer.

In an embodiment, the first indication may be a one-bit indication, a Boolean value, or a field whose presence indicates that the first terminal device is performing the switching procedure.

The receiving unit 1910 and the performing unit 1920 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions of the embodiments described above, and illustrated, e.g., in FIG. 9.

Correspondingly to the method 1000 as described above, a second terminal device is provided. FIG. 20 is a block diagram of a second terminal device 2000 according to an embodiment of the present disclosure.

The second terminal device is serving as a relay for a first terminal device towards a first network node or is a candidate to serve as a relay for the first terminal device towards the first network node or a second network node.

As shown in FIG. 20, the second terminal device 2000 includes a receiving unit 2010 configured to receive, from the first network node or the second network node, a handover command. The second terminal device 1900 further includes a transmitting unit 2020 configured to: transmit a measurement report to the first network node or the second network node, and transmit a first indication to the first terminal device, the first indication indicating that the second terminal device is performing a handover procedure.

In an embodiment, the measurement report may include one or more of: a first link measurement between the second terminal device and the first or second network node, and a second link measurement between the second terminal device and a third network node.

In an embodiment, the first indication may be directly transmitted to the first terminal device, using: RRC signaling, PC5-S, discovery signaling, MAC CE, L1 signaling, or control PDU of a protocol layer.

In an embodiment, the first indication may be transmitted to the first network node or the second network node for forwarding towards the first terminal device, using: RRC signaling, MAC CE, L1 signaling, or control PDU of a protocol layer.

In an embodiment, the first indication may be a one-bit indication, a Boolean value, or a field whose presence indicates that the second terminal device is performing the handover procedure.

The receiving unit 2010 and the transmitting unit 2020 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions of the embodiments described above, and illustrated, e.g., in FIG. 10.

FIG. 21 is a block diagram of a second terminal device 2100 according to another embodiment of the present disclosure.

The second terminal device is serving as a relay for a first terminal device towards a first network node or is a candidate to serve as a relay for the first terminal device towards the first network node or a second network node.

The second terminal device 2100 includes a transceiver 2110, a processor 2120 and a memory 2130. The memory 2130 may contain instructions executable by the processor 2120 whereby the second terminal device 2100 is operative to perform the actions, e.g., of the procedure described earlier in conjunction with FIG. 9. Particularly, the memory 2130 contains instructions executable by the processor 2120 whereby the second terminal device 2100 is operative to: receive a first indication from the first terminal device, the first indication indicating that the first terminal device is performing a switching procedure to switch to a direct link with the first network node or the second network node or to a link towards the first network node or the second network node with the second terminal device as the relay; and perform an operation in response to receiving the first indication.

In an embodiment, the operation may include: delaying, when a triggering criterion for transmitting a measurement report is fulfilled, transmission of the measurement report to the first network node or the second network node.

In an embodiment, the operation of delaying may include: delaying the transmission of the measurement report by a predetermined time length.

In an embodiment, the operation of delaying may include: delaying the transmission of the measurement report until a second indication indicating that the switching procedure is completed is received from the first terminal device or the first network node or the second network node.

In an embodiment, the operation may include: transmitting, when a triggering criterion for transmitting a measurement report is fulfilled, the measurement report to the first network node or the second network node. The measurement report contains the first indication indicating that the first terminal device is performing the switching procedure.

In an embodiment, the operation may include, when a triggering criterion for transmitting a measurement report is fulfilled: transmitting the measurement report to the first network node or the second network node; receiving, from the first network node or the second network node, a handover command; and transmitting, to the first terminal device, a third indication indicating that the second terminal device is performing a handover procedure, and/or triggering release of a link between the first terminal device and the second terminal device.

In an embodiment, the operation may further include, subsequent to transmitting the third indication: transmitting, to the first network node, a fourth indication indicating that the third indication has been transmitted to the first terminal device.

In an embodiment, the operation may include: changing a triggering criterion for transmitting a measurement report to be more difficult to be fulfilled.

In an embodiment, the triggering criterion may include at least one of a threshold, an offset, and a hypothesis.

In an embodiment, the operation may include, when a triggering criterion for transmitting a measurement report is fulfilled: initiating a cell reselection, without transmitting the measurement report to the first network node or the second network node.

In an embodiment, the measurement report may include one or more of: a first link measurement between the second terminal device and the first or second network node, and a second link measurement between the second terminal device and a third network node.

In an embodiment, the memory 2130 may further contain instructions executable by the processor 2120 whereby the second terminal device 2100 is operative to: receive, from the first network node, the second network node, or another control device, an instruction or configuration to perform the operation in response to receiving the first indication.

In an embodiment, the first indication may be received directly from the first terminal device, using: RRC signaling, PC5-S, discovery signaling, MAC CE, L1 signaling, or control PDU of a protocol layer.

In an embodiment, the first indication may be forwarded by the first network node or the second network node, using: RRC signaling, MAC CE, L1 signaling, or control PDU of a protocol layer.

In an embodiment, the first indication may be a one-bit indication, a Boolean value, or a field whose presence indicates that the first terminal device is performing the switching procedure.

Alternatively, the memory 2130 may contain instructions executable by the processor 2120 whereby the second terminal device 2100 is operative to perform the actions, e.g., of the procedure described earlier in conjunction with FIG. 10. Particularly, the memory 2130 contains instructions executable by the processor 2120 whereby the second terminal device 2100 is operative to: transmit a measurement report to the first network node or the second network node; receive, from the first network node or the second network node, a handover command; and transmit a first indication to the first terminal device, the first indication indicating that the second terminal device is performing a handover procedure.

In an embodiment, the measurement report may include one or more of: a first link measurement between the second terminal device and the first or second network node, and a second link measurement between the second terminal device and a third network node.

In an embodiment, the first indication may be directly transmitted to the first terminal device, using: RRC signaling, PC5-S, discovery signaling, MAC CE, L1 signaling, or control PDU of a protocol layer.

In an embodiment, the first indication may be transmitted to the first network node or the second network node for forwarding towards the first terminal device, using: RRC signaling, MAC CE, L1 signaling, or control PDU of a protocol layer.

In an embodiment, the first indication may be a one-bit indication, a Boolean value, or a field whose presence indicates that the second terminal device is performing the handover procedure.

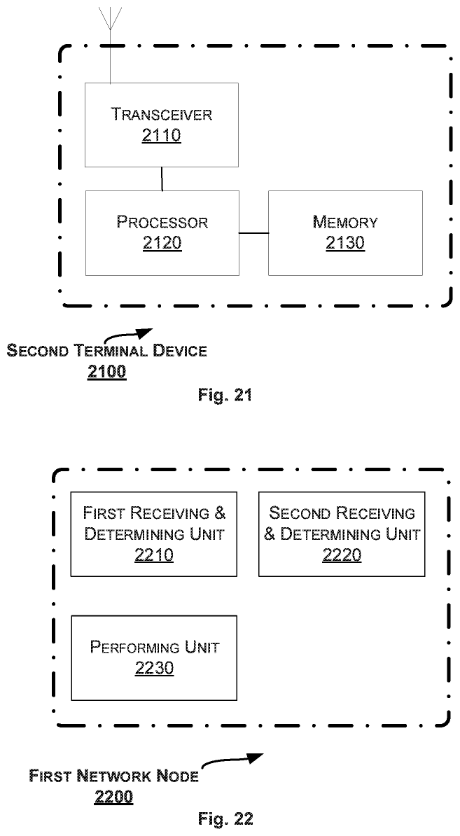

Correspondingly to the method 1100 as described above, a first network node is provided. FIG. 22 is a block diagram of a first network node 2200 according to an embodiment of the present disclosure.

The first network node is serving a first terminal device, and the first terminal device has a second terminal device serving as a relay towards the first network node or being a candidate to serve as a relay towards the first network node.

As shown in FIG. 22, the first network node 2200 includes a first receiving and determining unit 2210 configured to: receive a first measurement report from the first terminal device and determine based on the first measurement report that a first criterion for initiating a switching procedure for the first terminal device is fulfilled. The switching procedure is for the first terminal device to switch to a direct link with the first network node or a second network node or to a link towards the first network node with the second terminal device as the relay. The first network node 2200 further includes a second receiving and determining unit 2220 configured to receive a second measurement report from the second terminal device and determine based on the second measurement report that a second criterion for initiating a handover procedure for the second terminal device is fulfilled. The first network node 2200 further includes a performing unit 2230 configured to: perform an operation in response to determining that the first criterion is fulfilled and/or determining that the second criterion is fulfilled.

In an embodiment, the operation may include: transmitting, to the first terminal device in response to determining that the second criterion is fulfilled, a first indication indicating that transmission of the first measurement report is prohibited; or transmitting, to the second terminal device in response to determining that the first criterion is fulfilled, a second indication indicating that transmission of the second measurement report is prohibited.

In an embodiment, the operation may further include: transmitting, to the first terminal device, a third indication indicating that transmission of the first measurement report is allowed, when the handover procedure is completed; or transmitting, to the second terminal device, a fourth indication indicating that transmission of the second measurement report is allowed, when the switching procedure is completed.

In an embodiment, the third indication may contain an identifier of a third network node to which the second terminal device has been handed over.

In an embodiment, the fourth indication may further indicate whether the first terminal device has switched to the direct link with the first network node or the second network node or to a link towards the first network node with the second terminal device as the relay.

In an embodiment, the operation may further include, in response to determining that the first criterion is fulfilled and determining that the second criterion is fulfilled: transmitting a first instruction to perform the switching procedure to the first terminal device, and transmitting a second instruction to perform the handover procedure to the second terminal device after the switching procedure is completed; or transmitting the second instruction to perform the handover procedure to the second terminal device, and transmitting the first instruction to perform the switching procedure to the first terminal device after the handover procedure is completed.

In an embodiment, the first instruction may be transmitted before the second instruction when the first measurement report is received before the second measurement report.

In an embodiment, the second instruction may be transmitted before the first instruction when the second measurement report is received before the first measurement report.

In an embodiment, the first instruction may be transmitted before the second instruction when the switching procedure has a higher priority than the handover procedure.

In an embodiment, the second instruction may be transmitted before the first instruction when the handover procedure has a higher priority than the switching procedure.

In an embodiment, the priority of the switching procedure may be dependent on a signal strength or quality of a serving link of the first terminal device, an LCH priority of a radio bearer on which the serving link of the first terminal device is operating, or a first fixed priority.

In an embodiment, the priority of the handover procedure may be dependent on a signal strength or quality of a serving link of the second terminal device, an LCH priority of a radio bearer on which the serving link of the second terminal device is operating, or a second fixed priority.

In an embodiment, the operation may include, when the second terminal device is serving as the relay: transmitting, in response to determining that the first criterion is fulfilled and determining that the second criterion is fulfilled, a second instruction to perform the handover procedure to the second terminal device and releasing a link between the first terminal device and the second terminal device.

In an embodiment, the operation may include: configuring, in response to determining that the first criterion is fulfilled and determining that the second criterion is fulfilled, the first terminal device and/or the second terminal device to enter an RRC_IDLE or RRC_INACTIVE state.

In an embodiment, the first measurement report may include one or more of: a first link measurement between the first terminal device and the first network node, a second link measurement between the first terminal device and the second network node, a third link measurement between the first terminal device and the second terminal device, and a fourth link measurement between the first terminal device and a third terminal device.

In an embodiment, the second measurement report may include one or more of: a fifth link measurement between the second terminal device and the first network node, and a sixth link measurement between the second terminal device and a third network node.

In an embodiment, the first measurement report may be received directly from the first terminal device, and/or the second measurement report is received directly from the second terminal device, using: RRC signaling, MAC CE, L1 signaling, or control PDU of a protocol layer.

The first receiving and determining unit 2210, the second receiving and determining unit 2220, and the performing unit 2230 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions of the embodiments described above, and illustrated, e.g., in FIG. 11.

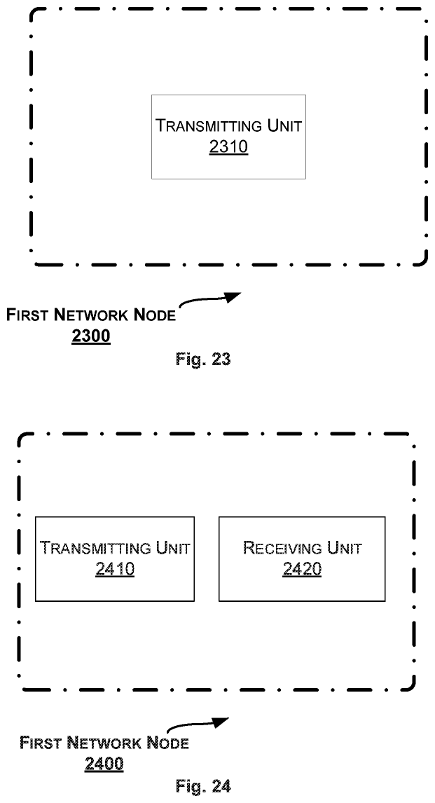

Correspondingly to the method 1200 as described above, a first network node is provided. FIG. 23 is a block diagram of a first network node 2300 according to an embodiment of the present disclosure.

The first network node is serving a first terminal device, and the first terminal device has a second terminal device being a candidate to serve as a relay towards a second network node.

As shown in FIG. 23, the first network node 2300 includes a transmitting unit 2310 configured to: transmit, to the first terminal device, an instruction or configuration to perform an operation in response to receiving an indication from the second terminal device. The indication indicates that the second terminal device is performing a handover procedure.

In an embodiment, the operation may include one or more of:
delaying, when a triggering criterion for transmitting a measurement report is fulfilled, transmission of the measurement report to the first network node,
initiating, when a triggering criterion for transmitting a measurement report is fulfilled, a cell reselection, relay discovery, or relay reselection procedure, or entering an RRC, IDLE or INACTIVE state, without transmitting the measurement report to the first network node,
changing a triggering criterion for transmitting a measurement report to be more difficult to be fulfilled, and
transmitting, when the second terminal device is the candidate to serve as the relay and when a triggering criterion for transmitting a measurement report is fulfilled, a measurement report to the first network node, the measurement report including a first link measurement between the first terminal device and the first network node and/or a second link measurement between the first terminal device and the second network node and/or a fourth link measurement between the first terminal device and a third terminal device, and excluding a third link measurement between the first terminal device and the second terminal device.

The transmitting unit 2310 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions of the embodiments described above, and illustrated, e.g., in FIG. 12.

Correspondingly to the method 1300 as described above, a first network node is provided. FIG. 24 is a block diagram of a first network node 2400 according to an embodiment of the present disclosure.

The first network node is serving a first terminal device, and the first terminal device has a second terminal device being a candidate to serve as a relay towards a second network node.

As shown in FIG. 24, the first network node 2400 includes a transmitting unit 2410 configured to: transmit a first indication to the second network node. The first indication indicates that the first terminal device is performing a switching procedure to switch to a link towards the second network node with the second terminal device as the relay. Alternatively, the first network node 2400 includes a receiving unit 2420 configured to: receive a second indication from the second network node. The second indication indicates that the second terminal device is performing a handover procedure.

In an embodiment, the transmitting unit 2410 may be further configured to: in response to receiving the second indication: forward the second indication to the first terminal device; or transmit, to the first terminal device, a third indication indicating that transmission of the first measurement report is prohibited.

In an embodiment, the receiving unit 2420 may be further configured to: receive, from the second network node, a fourth indication indicating that the handover procedure is completed. The transmitting unit 2410 may be further configured to: forward the fourth indication to the first terminal device or transmit, to the first terminal device, a fifth indication indicating that transmission of the first measurement report is allowed.

In an embodiment, the first indication may be transmitted and/or the second indication is received, using: X2/X1 signaling, F1 signaling, or RRC message.

In an embodiment, the first indication may be a one-bit indication, a Boolean value, or a field whose presence indicates that the first terminal device is performing the switching procedure.

In an embodiment, the second indication may be a one-bit indication, a Boolean value, or a field whose presence indicates that the second terminal device is performing the handover procedure.

The transmitting unit 2410 and the receiving unit 2420 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions of the embodiments described above, and illustrated, e.g., in FIG. 13.

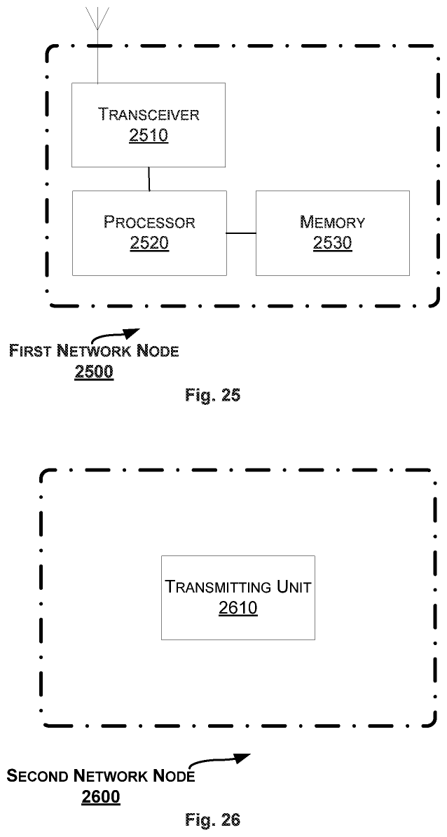

FIG. 25 is a block diagram of a first network node 2500 according to another embodiment of the present disclosure.

The first network node 2500 includes a transceiver 2510, a processor 2520 and a memory 2530.

The first network node is serving a first terminal device, and the first terminal device has a second terminal device serving as a relay towards the first network node or being a candidate to serve as a relay towards the first network node. The memory 2530 may contain instructions executable by the processor 2520 whereby the first network node 2500 is operative to perform the actions, e.g., of the procedure described earlier in conjunction with FIG. 11. Particularly, the memory 2530 contains instructions executable by the processor 2520 whereby the first network node 2500 is operative to: receive a first measurement report from the first terminal device and determine based on the first measurement report that a first criterion for initiating a switching procedure for the first terminal device is fulfilled, the switching procedure being for the first terminal device to switch to a direct link with the first network node or a second network node or to a link towards the first network node with the second terminal device as the relay, and/or receive a second measurement report from the second terminal device and determine based on the second measurement report that a second criterion for initiating a handover procedure for the second terminal device is fulfilled; and perform an operation in response to determining that the first criterion is fulfilled and/or determining that the second criterion is fulfilled.

In an embodiment, the operation may include: transmitting, to the first terminal device in response to determining that the second criterion is fulfilled, a first indication indicating that transmission of the first measurement report is prohibited; or transmitting, to the second terminal device in response to determining that the first criterion is fulfilled, a second indication indicating that transmission of the second measurement report is prohibited.

In an embodiment, the operation may further include: transmitting, to the first terminal device, a third indication indicating that transmission of the first measurement report is allowed, when the handover procedure is completed; or transmitting, to the second terminal device, a fourth indication indicating that transmission of the second measurement report is allowed, when the switching procedure is completed.

In an embodiment, the third indication may contain an identifier of a third network node to which the second terminal device has been handed over.

In an embodiment, the fourth indication may further indicate whether the first terminal device has switched to the direct link with the first network node or the second network node or to a link towards the first network node with the second terminal device as the relay.

In an embodiment, the operation may further include, in response to determining that the first criterion is fulfilled and determining that the second criterion is fulfilled: transmitting a first instruction to perform the switching procedure to the first terminal device, and transmitting a second instruction to perform the handover procedure to the second terminal device after the switching procedure is completed; or transmitting the second instruction to perform the handover procedure to the second terminal device, and transmitting the first instruction to perform the switching procedure to the first terminal device after the handover procedure is completed.

In an embodiment, the first instruction may be transmitted before the second instruction when the first measurement report is received before the second measurement report.

In an embodiment, the second instruction may be transmitted before the first instruction when the second measurement report is received before the first measurement report.

In an embodiment, the first instruction may be transmitted before the second instruction when the switching procedure has a higher priority than the handover procedure.

In an embodiment, the second instruction may be transmitted before the first instruction when the handover procedure has a higher priority than the switching procedure.

In an embodiment, the priority of the switching procedure may be dependent on a signal strength or quality of a serving link of the first terminal device, an LCH priority of a radio bearer on which the serving link of the first terminal device is operating, or a first fixed priority.

In an embodiment, the priority of the handover procedure may be dependent on a signal strength or quality of a serving link of the second terminal device, an LCH priority of a radio bearer on which the serving link of the second terminal device is operating, or a second fixed priority.

In an embodiment, the operation may include, when the second terminal device is serving as the relay: transmitting, in response to determining that the first criterion is fulfilled and determining that the second criterion is fulfilled, a second instruction to perform the handover procedure to the second terminal device and releasing a link between the first terminal device and the second terminal device.

In an embodiment, the operation may include: configuring, in response to determining that the first criterion is fulfilled and determining that the second criterion is fulfilled, the first terminal device and/or the second terminal device to enter an RRC_IDLE or RRC_INACTIVE state.

In an embodiment, the first measurement report may include one or more of: a first link measurement between the first terminal device and the first network node, a second link measurement between the first terminal device and the second network node, a third link measurement between the first terminal device and the second terminal device, and a fourth link measurement between the first terminal device and a third terminal device.

In an embodiment, the second measurement report may include one or more of: a fifth link measurement between the second terminal device and the first network node, and a sixth link measurement between the second terminal device and a third network node.

In an embodiment, the first measurement report may be received directly from the first terminal device, and/or the second measurement report is received directly from the second terminal device, using: RRC signaling, MAC CE, L1 signaling, or control PDU of a protocol layer.

Alternatively, the first network node is serving a first terminal device, and the first terminal device has a second terminal device being a candidate to serve as a relay towards a second network node. The memory 2530 may contain instructions executable by the processor 2520 whereby the first network node 2500 is operative to perform the actions, e.g., of the procedure described earlier in conjunction with FIG. 12. Particularly, the memory 2530 contains instructions executable by the processor 2520 whereby the first network node 2500 is operative to: transmit, to the first terminal device, an instruction or configuration to perform an operation in response to receiving an indication from the second terminal device. The indication indicates that the second terminal device is performing a handover procedure.

In an embodiment, the operation may include one or more of:
delaying, when a triggering criterion for transmitting a measurement report is fulfilled, transmission of the measurement report to the first network node,
initiating, when a triggering criterion for transmitting a measurement report is fulfilled, a cell reselection, relay discovery, or relay reselection procedure, or entering a Radio Resource Control, RRC, IDLE or INACTIVE state, without transmitting the measurement report to the first network node,
changing a triggering criterion for transmitting a measurement report to be more difficult to be fulfilled, and
transmitting, when the second terminal device is the candidate to serve as the relay and when a triggering criterion for transmitting a measurement report is fulfilled, a measurement report to the first network node, the measurement report including a first link measurement between the first terminal device and the first network node and/or a second link measurement between the first terminal device and the second network node and/or a fourth link measurement between the first terminal device and a third terminal device, and excluding a third link measurement between the first terminal device and the second terminal device.

Alternatively, the first network node is serving the first terminal device, and the first terminal device has a second terminal device being a candidate to serve as a relay towards a second network node. The memory 2530 may contain instructions executable by the processor 2520 whereby the first network node 2500 is operative to perform the actions, e.g., of the procedure described earlier in conjunction with FIG. 13. Particularly, the memory 2530 contains instructions executable by the processor 2520 whereby the first network node 2500 is operative to: transmit a first indication to the second network node, the first indication indicating that the first terminal device is performing a switching procedure to switch to a link towards the second network node with the second terminal device as the relay, or receive a second indication from the second network node, the second indication indicating that the second terminal device is performing a handover procedure.

In an embodiment, the memory 2530 may further contain instructions executable by the processor 2520 whereby the first network node 2500 is operative to: in response to receiving the second indication: forward the second indication to the first terminal device; or transmit, to the first terminal device, a third indication indicating that transmission of the first measurement report is prohibited.

In an embodiment, the memory 2530 may further contain instructions executable by the processor 2520 whereby the first network node 2500 is operative to: receive, from the second network node, a fourth indication indicating that the handover procedure is completed; and forward the fourth indication to the first terminal device or transmit, to the first terminal device, a fifth indication indicating that transmission of the first measurement report is allowed.

In an embodiment, the first indication may be transmitted and/or the second indication is received, using: X2/X1 signaling, F1 signaling, or RRC message.

In an embodiment, the first indication may be a one-bit indication, a Boolean value, or a field whose presence indicates that the first terminal device is performing the switching procedure.

In an embodiment, the second indication may be a one-bit indication, a Boolean value, or a field whose presence indicates that the second terminal device is performing the handover procedure.

Correspondingly to the method 1400 as described above, a second network node is provided. FIG. 26 is a block diagram of a second network node 2600 according to an embodiment of the present disclosure.

The second network node is serving a second terminal device, and the second terminal device is a candidate to serve as a relay for a first terminal device served by a first network node towards the second network node.

As shown in FIG. 26, the second network node 2600 includes a transmitting unit 2610 configured to: transmit, to the second terminal device, an instruction or configuration to perform an operation in response to receiving an indication from the first terminal device. The indication indicates that the first terminal device is performing a switching procedure to switch to a link towards the second network node with the second terminal device as the relay.

In an embodiment, the operation may include one or more of:
delaying, when a triggering criterion for transmitting a measurement report is fulfilled, transmission of the measurement report to the second network node,
transmitting, when a triggering criterion for transmitting a measurement report is fulfilled, the measurement report to the second network node, the measurement report containing an indication indicating that the first terminal device is performing the switching procedure,
when a triggering criterion for transmitting a measurement report is fulfilled: transmitting the measurement report to the second network node, receiving, from the second network node, a handover command; and transmitting, to the first network node for forwarding to the first terminal device, an indication indicating that the second terminal device is performing a handover procedure,
changing a triggering criterion for transmitting a measurement report to be more difficult to be fulfilled,
initiating, when a triggering criterion for transmitting a measurement report is fulfilled, a cell reselection, without transmitting the measurement report to the second network node.

The transmitting unit 2610 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions of the embodiments described above, and illustrated, e.g., in FIG. 14.

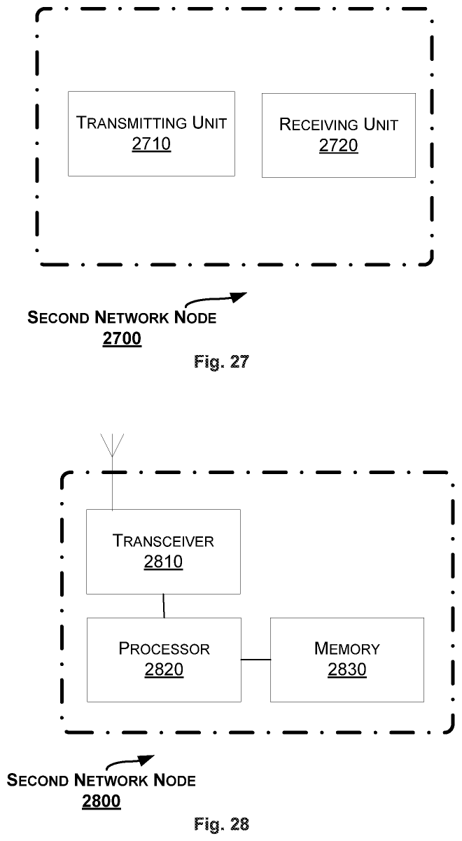

Correspondingly to the method 1500 as described above, a second network node is provided. FIG. 27 is a block diagram of a second network node 2700 according to an embodiment of the present disclosure.

The second network node is serving a second terminal device, and the second terminal device is a candidate to serve as a relay for a first terminal device served by a first network node towards the second network node.

As shown in FIG. 27, the second network node 2700 includes a transmitting unit 2710 configured to: transmit a second indication to the first network node, the second indication indicating that the second terminal device is performing a handover procedure. Alternatively, the second network node 2700 includes a receiving unit 2720 configured to receive a first indication from the first network node, the first indication indicating that the first terminal device is performing a switching procedure to switch to a link towards the second network node with the second terminal device as the relay.

In an embodiment, the transmitting unit 2710 may be further configured to: in response to receiving the first indication: forward the first indication to the second terminal device; or transmit, to the second terminal device, a third indication indicating that transmission of the second measurement report is prohibited.

In an embodiment, the receiving unit 2720 may be further configured to: receive, from the first network node, a fourth indication indicating that the switching procedure is completed. The transmitting unit 2710 may be configured to: forward the fourth indication to the second terminal device or transmit, to the second terminal device, a fifth indication indicating that transmission of the second measurement report is allowed.

In an embodiment, the second indication may be transmitted and/or the first indication may be received, using: X2/X1 signaling, F1 signaling, or inter-node RRC message.

In an embodiment, the first indication may be a one-bit indication, a Boolean value, or a field whose presence indicates that the first terminal device is performing the switching procedure.

In an embodiment, the second indication may be a one-bit indication, a Boolean value, or a field whose presence indicates that the second terminal device is performing the handover procedure.

The transmitting unit 2710 and the receiving unit 2720 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions of the embodiments described above, and illustrated, e.g., in FIG. 15.

FIG. 28 is a block diagram of a second network node 2800 according to another embodiment of the present disclosure.

The second network node is serving a second terminal device, and the second terminal device is a candidate to serve as a relay for a first terminal device served by a first network node towards the second network node.

The second network node 2800 includes a transceiver 2810, a processor 2820 and a memory 2830.

The memory 2830 may contain instructions executable by the processor 2820 whereby the second network node 2800 is operative to perform the actions, e.g., of the procedure described earlier in conjunction with FIG. 14. Particularly, the memory 2830 contains instructions executable by the processor 2820 whereby the second network node 2800 is operative to: transmit, to the second terminal device, an instruction or configuration to perform an operation in response to receiving an indication from the first terminal device. The indication indicates that the first terminal device is performing a switching procedure to switch to a link towards the second network node with the second terminal device as the relay.

In an embodiment, the operation may include one or more of:
delaying, when a triggering criterion for transmitting a measurement report is fulfilled, transmission of the measurement report to the second network node,
transmitting, when a triggering criterion for transmitting a measurement report is fulfilled, the measurement report to the second network node, the measurement report containing an indication indicating that the first terminal device is performing the switching procedure,
when a triggering criterion for transmitting a measurement report is fulfilled: transmitting the measurement report to the second network node, receiving, from the second network node, a handover command; and transmitting, to the first network node for forwarding to the first terminal device, an indication indicating that the second terminal device is performing a handover procedure,
changing a triggering criterion for transmitting a measurement report to be more difficult to be fulfilled,
initiating, when a triggering criterion for transmitting a measurement report is fulfilled, a cell reselection, without transmitting the measurement report to the second network node.

Alternatively, the memory 2830 may contain instructions executable by the processor 2820 whereby the second network node 2800 is operative to perform the actions, e.g., of the procedure described earlier in conjunction with FIG. 15. Particularly, the memory 2830 contains instructions executable by the processor 2820 whereby the second network node 2800 is operative to: transmit a second indication to the first network node, the second indication indicating that the second terminal device is performing a handover procedure, or receive a first indication from the first network node, the first indication indicating that the first terminal device is performing a switching procedure to switch to a link towards the second network node with the second terminal device as the relay.

In an embodiment, the memory 2830 may further contain instructions executable by the processor 2820 whereby the second network node 2800 is operative to: in response to receiving the first indication: forward the first indication to the second terminal device; or transmit, to the second terminal device, a third indication indicating that transmission of the second measurement report is prohibited.

In an embodiment, the memory 2830 may further contain instructions executable by the processor 2820 whereby the second network node 2800 is operative to: receive, from the first network node, a fourth indication indicating that the switching procedure is completed; and forward the fourth indication to the second terminal device or transmit, to the second terminal device, a fifth indication indicating that transmission of the second measurement report is allowed.

In an embodiment, the second indication may be transmitted and/or the first indication may be received, using: X2/X1 signaling, F1 signaling, or inter-node RRC message.

In an embodiment, the first indication may be a one-bit indication, a Boolean value, or a field whose presence indicates that the first terminal device is performing the switching procedure.

In an embodiment, the second indication may be a one-bit indication, a Boolean value, or a field whose presence indicates that the second terminal device is performing the handover procedure.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes:

code/computer readable instructions, which when executed by the processor 1820 causes the first terminal device 1800 to perform the actions, e.g., of the procedure described earlier in conjunction with FIG. 7 or 8; or code/computer readable instructions, which when executed by the processor 2120 causes the second terminal device 2100 to perform the actions, e.g., of the procedure described earlier in conjunction with FIG. 9 or 10, or code/computer readable instructions, which when executed by the processor 2520 causes the first network node 2500 to perform the actions, e.g., of the procedure described earlier in conjunction with FIG. 11, 12, or 13, or code/computer readable instructions, which when executed by the processor 2820 causes the second network node 2800 to perform the actions, e.g., of the procedure described earlier in conjunction with FIG. 14 or 15.

The computer program product may be configured as a computer program code structured in computer program modules. The computer program modules could essentially perform the actions of the flow illustrated in FIG. 7, 8, 9, 10, 11, 12, 13, 14, or 15.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-Access Memory (RAM), a Read-Only Memory (ROM), or an EEPROM, and the computer program modules described above could in alternative embodiments be distributed on different computer program products in the form of memories.

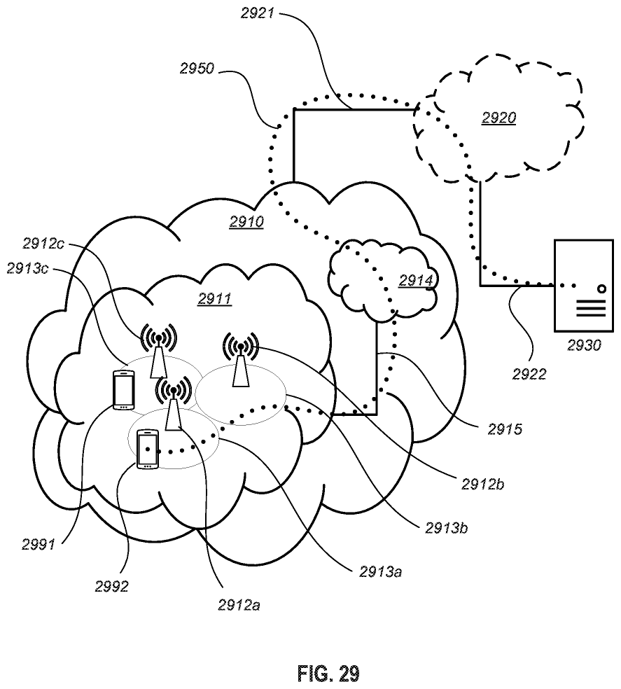

With reference to FIG. 29, in accordance with an embodiment, a communication system includes a telecommunication network 2910, such as a 3GPP-type cellular network, which comprises an access network 2911, such as a radio access network, and a core network 2914. The access network 2911 comprises a plurality of base stations 2912a, 2912b, 2912c, such as NBs, eNBs, gNBs or other types of wireless access points, each defining a corresponding coverage area 2913a, 2913b, 2913c. Each base station 2912a, 2912b, 2912c is connectable to the core network 2914 over a wired or wireless connection 2915. A first user equipment (UE) 2991 located in coverage area 2913c is configured to wirelessly connect to, or be paged by, the corresponding base station 2912c. A second UE 2992 in coverage area 2913a is wirelessly connectable to the corresponding base station 2912a. While a plurality of UEs 2991, 2992 are illustrated in this example, the disclosed embodiments are equally applicable to a situation where a sole UE is in the coverage area or where a sole UE is connecting to the corresponding base station 2912.

The telecommunication network 2910 is itself connected to a host computer 2930, which may be embodied in the hardware and/or software of a standalone server, a cloud-implemented server, a distributed server or as processing resources in a server farm. The host computer 2930 may be under the ownership or control of a service provider, or may be operated by the service provider or on behalf of the service provider. The connections 2921, 2922 between the telecommunication network 2910 and the host computer 2930 may extend directly from the core network 2914 to the host computer 2930 or may go via an optional intermediate network 2920. The intermediate network 2920 may be one of, or a combination of more than one of, a public, private or hosted network; the intermediate network 2920, if any, may be a backbone network or the Internet; in particular, the intermediate network 2920 may comprise two or more sub-networks (not shown).

The communication system of FIG. 29 as a whole enables connectivity between one of the connected UEs 2991, 2992 and the host computer 2930. The connectivity may be described as an over-the-top (OTT) connection 2950. The host computer 2930 and the connected UEs 2991, 2992 are configured to communicate data and/or signaling via the OTT connection 2950, using the access network 2911, the core network 2914, any intermediate network 2920 and possible further infrastructure (not shown) as intermediaries. The OTT connection 2950 may be transparent in the sense that the participating communication devices through which the OTT connection 2950 passes are unaware of routing of uplink and downlink communications. For example, a base station 2912 may not or need not be informed about the past routing of an incoming downlink communication with data originating from a host computer 2930 to be forwarded (e.g., handed over) to a connected UE 2991. Similarly, the base station 2912 need not be aware of the future routing of an outgoing uplink communication originating from the UE 2991 towards the host computer 2930.

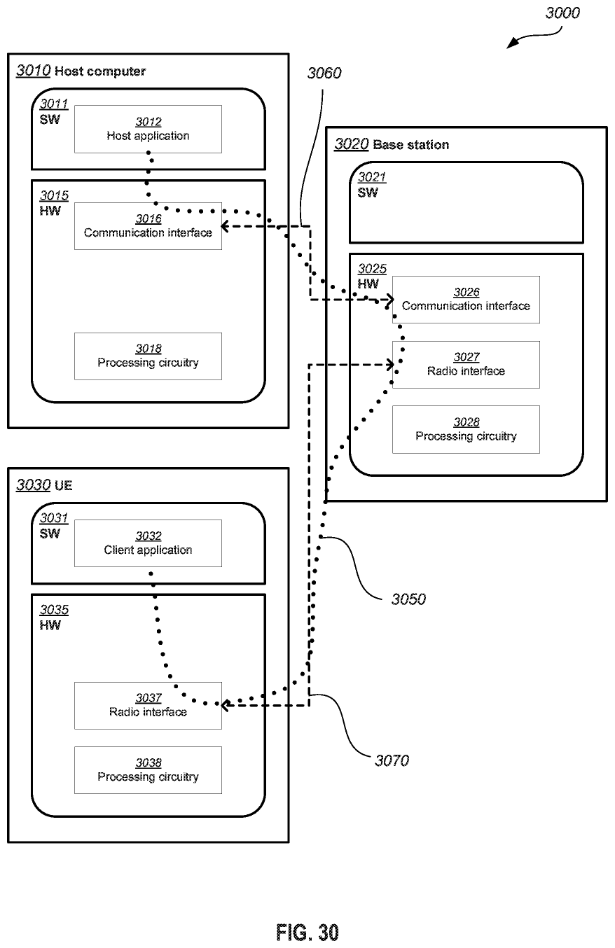

Example implementations, in accordance with an embodiment, of the UE, base station and host computer discussed in the preceding paragraphs will now be described with reference to FIG. 30. In a communication system 3000, a host computer 3010 comprises hardware 3015 including a communication interface 3016 configured to set up and maintain a wired or wireless connection with an interface of a different communication device of the communication system 3000. The host computer 3010 further comprises processing circuitry 3018, which may have storage and/or processing capabilities. In particular, the processing circuitry 3018 may comprise one or more programmable processors, application-specific integrated circuits, field programmable gate arrays or combinations of these (not shown) adapted to execute instructions. The host computer 3010 further comprises software 3011, which is stored in or accessible by the host computer 3010 and executable by the processing circuitry 3018. The software 3011 includes a host application 3012. The host application 3012 may be operable to provide a service to a remote user, such as a UE 3030 connecting via an OTT connection 3050 terminating at the UE 3030 and the host computer 3010. In providing the service to the remote user, the host application 3012 may provide user data which is transmitted using the OTT connection 3050.

The communication system 3000 further includes a base station 3020 provided in a telecommunication system and comprising hardware 3025 enabling it to communicate with the host computer 3010 and with the UE 3030. The hardware 3025 may include a communication interface 3026 for setting up and maintaining a wired or wireless connection with an interface of a different communication device of the communication system 3000, as well as a radio interface 3027 for setting up and maintaining at least a wireless connection 3070 with a UE 3030 located in a coverage area (not shown in FIG. 30) served by the base station 3020. The communication interface 3026 may be configured to facilitate a connection 3060 to the host computer 3010. The connection 3060 may be direct or it may pass through a core network (not shown in FIG. 30) of the telecommunication system and/or through one or more intermediate networks outside the telecommunication system. In the embodiment shown, the hardware 3025 of the base station 3020 further includes processing circuitry 3028, which may comprise one or more programmable processors, application-specific integrated circuits, field programmable gate arrays or combinations of these (not shown) adapted to execute instructions. The base station 3020 further has software 3021 stored internally or accessible via an external connection.

The communication system 3000 further includes the UE 3030 already referred to. Its hardware 3035 may include a radio interface 3037 configured to set up and maintain a wireless connection 3070 with a base station serving a coverage area in which the UE 3030 is currently located. The hardware 3035 of the UE 3030 further includes processing circuitry 3038, which may comprise one or more programmable processors, application-specific integrated circuits, field programmable gate arrays or combinations of these (not shown) adapted to execute instructions. The UE 3030 further comprises software 3031, which is stored in or accessible by the UE 3030 and executable by the processing circuitry 3038. The software 3031 includes a client application 3032. The client application 3032 may be operable to provide a service to a human or non-human user via the UE 3030, with the support of the host computer 3010. In the host computer 3010, an executing host application 3012 may communicate with the executing client application 3032 via the OTT connection 3050 terminating at the UE 3030 and the host computer 3010. In providing the service to the user, the client application 3032 may receive request data from the host application 3012 and provide user data in response to the request data. The OTT connection 3050 may transfer both the request data and the user data. The client application 3032 may interact with the user to generate the user data that it provides.

It is noted that the host computer 3010, base station 3020 and UE 3030 illustrated in FIG. 30 may be identical to the host computer 1530, one of the base stations 1512a, 1512b, 1512c and one of the UEs 1591, 1592 of FIG. 15, respectively. This is to say, the inner workings of these entities may be as shown in FIG. 30 and independently, the surrounding network topology may be that of FIG. 15.

In FIG. 30, the OTT connection 3050 has been drawn abstractly to illustrate the communication between the host computer 3010 and the use equipment 3030 via the base station 3020, without explicit reference to any intermediary devices and the precise routing of messages via these devices. Network infrastructure may determine the routing, which it may be configured to hide from the UE 3030 or from the service provider operating the host computer 3010, or both. While the OTT connection 3050 is active, the network infrastructure may further take decisions by which it dynamically changes the routing (e.g., on the basis of load balancing consideration or reconfiguration of the network).

The wireless connection 3070 between the UE 3030 and the base station 3020 is in accordance with the teachings of the embodiments described throughout this disclosure. One or more of the various embodiments improve the performance of OTT services provided to the UE 3030 using the OTT connection 3050, in which the wireless connection 3070 forms the last segment. More precisely, the teachings of these embodiments may improve service continuity and latency and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 3050 between the host computer 3010 and UE 3030, in response to variations in the measurement results. The measurement procedure and/or the network functionality for reconfiguring the OTT connection 3050 may be implemented in the software 3011 of the host computer 3010 or in the software 3031 of the UE 3030, or both. In embodiments, sensors (not shown) may be deployed in or in association with communication devices through which the OTT connection 3050 passes; the sensors may participate in the measurement procedure by supplying values of the monitored quantities exemplified above, or supplying values of other physical quantities from which software 3011, 3031 may compute or estimate the monitored quantities. The reconfiguring of the OTT connection 3050 may include message format, retransmission settings, preferred routing etc.; the reconfiguring need not affect the base station 3020, and it may be unknown or imperceptible to the base station 3020. Such procedures and functionalities may be known and practiced in the art. In certain embodiments, measurements may involve proprietary UE signaling facilitating the host computer's 3010 measurements of throughput, propagation times, latency and the like. The measurements may be implemented in that the software 3011, 3031 causes messages to be transmitted, in particular empty or ‘dummy’ messages, using the OTT connection 3050 while it monitors propagation times, errors etc.

FIG. 31 is a flowchart illustrating a method implemented in a communication system, in accordance with one embodiment. The communication system includes a host computer, a base station and a UE which may be those described with reference to FIGS. 29 and 30. For simplicity of the present disclosure, only drawing references to FIG. 31 will be included in this section. In a first step 3110 of the method, the host computer provides user data. In an optional substep 3111 of the first step 3110, the host computer provides the user data by executing a host application. In a second step 3120, the host computer initiates a transmission carrying the user data to the UE. In an optional third step 3130, the base station transmits to the UE the user data which was carried in the transmission that the host computer initiated, in accordance with the teachings of the embodiments described throughout this disclosure. In an optional fourth step 3140, the UE executes a client application associated with the host application executed by the host computer.

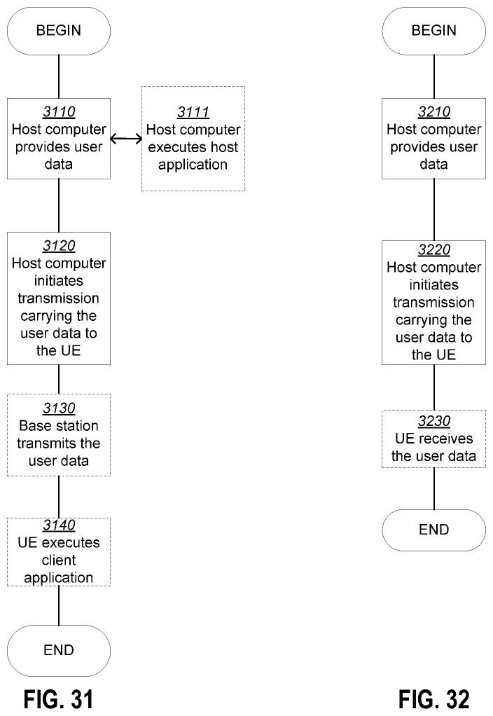

FIG. 32 is a flowchart illustrating a method implemented in a communication system, in accordance with one embodiment. The communication system includes a host computer, a base station and a UE which may be those described with reference to FIGS. 29 and 30. For simplicity of the present disclosure, only drawing references to FIG. 32 will be included in this section. In a first step 3210 of the method, the host computer provides user data. In an optional substep (not shown) the host computer provides the user data by executing a host application. In a second step 3220, the host computer initiates a transmission carrying the user data to the UE. The transmission may pass via the base station, in accordance with the teachings of the embodiments described throughout this disclosure. In an optional third step 3230, the UE receives the user data carried in the transmission.

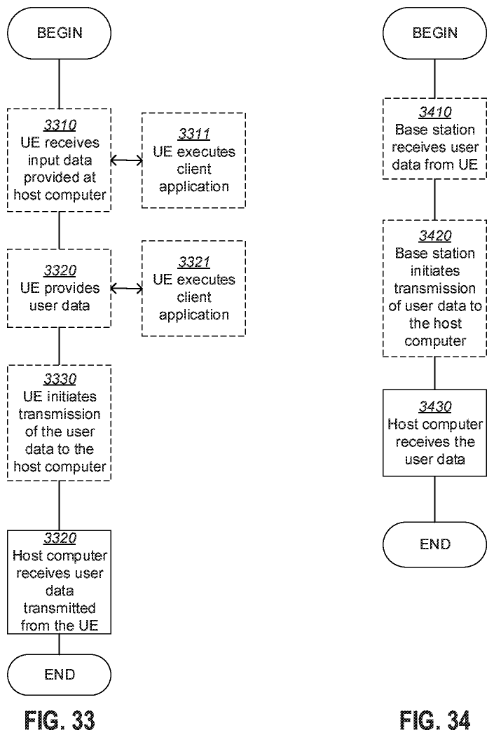

FIG. 33 is a flowchart illustrating a method implemented in a communication system, in accordance with one embodiment. The communication system includes a host computer, a base station and a UE which may be those described with reference to FIGS. 29 and 30. For simplicity of the present disclosure, only drawing references to FIG. 33 will be included in this section. In an optional first step 3310 of the method, the UE receives input data provided by the host computer. Additionally or alternatively, in an optional second step 3320, the UE provides user data. In an optional substep 3321 of the second step 3320, the UE provides the user data by executing a client application. In a further optional substep 3311 of the first step 3310, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3330, transmission of the user data to the host computer. In a fourth step 3340 of the method, the host computer receives the user data transmitted from the UE, in accordance with the teachings of the embodiments described throughout this disclosure.

FIG. 34 is a flowchart illustrating a method implemented in a communication system, in accordance with one embodiment. The communication system includes a host computer, a base station and a UE which may be those described with reference to FIGS. 29 and 30. For simplicity of the present disclosure, only drawing references to FIG. 34 will be included in this section. In an optional first step 3410 of the method, in accordance with the teachings of the embodiments described throughout this disclosure, the base station receives user data from the UE. In an optional second step 3420, the base station initiates transmission of the received user data to the host computer. In a third step 3430, the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

The present disclosure further provides the following embodiments.

The embodiments are described in the context of NR, i.e., remote UE and relay UE are deployed in a same or different NR cell. The embodiments are also applicable to other relay scenarios including UE to network relay or UE to UE relay where the remote UE and the relay UE may be based on LTE sidelink or NR sidelink, the Uu connection between the relay UE and the base station may be LTE Uu or NR Uu.

Terms “direct connection” or “direct path” are used to stand for a connection between a UE and a gNB, while terms “indirect connection” or “indirect path” are used to stand for a connection between a remote UE and gNB via a relay UE. In addition, the term “path switch” is used when the remote UE changes between a direct path (i.e., Uu connection) and an indirect path (i.e., relay connection via a SL relay UE). The other term such as “relay selection/reselection” is equally applicable here without losing any meaning. On the other hand, the term “handover” is used to stand for a change of serving cell.

The below embodiments focus on the scenario where the remote UE performs a path switch and the relay UE performs a handover at the same time.

### EMBODIMENTS

In one embodiment, the remote UE sends a measurement report to the gNB by including Uu and PC5 measurements. Once received this measurement report, in case the gNB triggers a path switch procedure, it sends an RRC reconfiguration message to the remote UE with a new configuration to be applied (in order to switch from one path to another). The remote UE, when performing the path switch procedure, upon receiving the RRC reconfiguration from the network, it sends an indication to the relay UE (i.e., serving relay UE and/or candidate relay UE, depending of the type of path switch and whether the remote UE has multiple relay UEs) in order to inform that a path switch procedure has been triggered.

In another embodiment, upon receiving an indication from a remote UE that a path switch procedure is ongoing and performed by the remote UE, the relay UE is configured to perform at least one (or a combination) of the following actions:
If some of the (legacy) triggering criteria for sending a measurement report are fulfilled, the relay UE delay the sending of its measurement report to the network by the duration of a timer. This means that the relay UE, upon receiving the indication from the remote UE that a path switch procedure is ongoing, it starts a timer, and the measurement report is sent by the relay UE only when the timer expires. The timer may be configured by the NW or hard coded in the spec.
If some of the (legacy) triggering criteria for sending a measurement report are fulfilled, the relay UE holds the sending of its measurement report to the network to when the remote UE completed the path switch procedure. This basically means that when the path switch procedure is concluded, either the remote UE or the network needs to send an indication to the relay UE.
If some of the (legacy) triggering criteria for sending a measurement report are fulfilled, the relay UE sends its measurement report to the network, but it also includes an indication in the measurement report that there is a path switch procedure ongoing at the remote UE. This basically means that the relay UE will wait for the network to trigger both the path switch and the (inter-gNB) handover without interfering to each other.
If some of the (legacy) triggering criteria for sending a measurement report are fulfilled, the relay UE sends its measurement report to the gNB and, when receiving a HO command (for inter-gNB handover), explicitly informs the remote UE that a (inter-gNB) handover is ongoing or implicitly informs it by triggering the PC5 release towards the remote UE (this mean that the sidelink relay connection is released). This may happen in case the relay UE has latency-sensitive traffic (e.g., URLLC) and so that the network and/or the relay UE does not want to prioritize the path switch over the (inter-gNB) handover. The relay UE may also inform the network that it has informed the remote UE about the ongoing (inter-gNB) HO to facilitate the network to take actions to avoid that the two procedures are collided to each other. Further, when the remote UE received the informing from a relay UE, it may do the following:
   Aborts an already started path switch since the path switch procedure cannot be continued and performs link reestablishment.
   If the informing is from a candidate relay UE, the remote UE informs its serving gNB that the candidate relay UE is no more available, which in turn directs the remote UE to switch to another (direct or indirect) path.
For a candidate relay UE, if some of the (legacy) triggering criteria for sending a measurement report are fulfilled, the relay UE does not send any measurement report to the network but instead it starts the cell (re)selection procedure in order to establish a new Uu connection towards a new serving cell which is faster than HO. The benefit is that the interruption time will be shorter when the remote UE performs path switch to the candidate relay UE.

Alternatively, or in addition, new triggering criteria for sending a measurement report may be configured for a relay UE, for instance, the parameters (such as thresholds/offsets/hypothesis etc.) used in the measurement events may be configured which should be applied when the relay UE has received an indication from a remote UE that a path switch procedure is being performed by the remote UE. The parameters should be configured in a way that the relay UE will send the measurement report later compared to measurement reports triggered by the legacy triggering criteria.

In one embodiment, the relay UE sends a measurement report to the source gNB by including Uu measurements. Once received this measurement report, in case the source gNB triggers a handover procedure, it sends a handover command message (received by the target cell) to the relay UE with a new configuration to be applied (in order to switch to the target cell). The relay UE, when performing the handover procedure, upon receiving the handover command from the source cell, it sends an indication to the remote UE in order to inform that a handover procedure has been triggered and is ongoing. The relay UE may only send this indication when performing inter-gNB handover.

In another embodiment, upon receiving an indication from a relay UE that a (inter-gNB) handover procedure is ongoing and performed by the relay UE, the remote UE performs at least one (or a combination) of the following actions:
If some of the (legacy) triggering criteria for sending a measurement report are fulfilled, the remote UE delay the sending of its measurement report to the network by the duration of a timer. This means that the remote UE, upon receiving the indication from the relay UE that a (inter-gNB) handover procedure is ongoing, it starts a timer, and the measurement report is sent by the remote UE only when the timer expires. The timer may be configured by the NW or hard coded in the spec.
If some of the (legacy) triggering criteria for sending a measurement report are fulfilled, the remote UE holds the sending of its measurement report to the network to when the relay UE completed the (inter-gNB) handover procedure. This basically means that when the (inter-gNB) handover procedure is concluded, either the relay UE or the network needs to send an indication to the remote UE.
If some of the (legacy) triggering criteria for sending a measurement report are fulfilled, the remote UE sends its measurement report to the network, but it also includes an indication in the measurement report that there is a (inter-gNB) handover procedure ongoing at the (candidate) relay UE(s). This basically means that the remote UE will wait for the network to trigger both the path switch and the (inter-gNB) handover without interfering to each other.
If some of the (legacy) triggering criteria for sending a measurement report are fulfilled, the remote UE sends its measurement report but excludes the measurement results of the candidate relay UE(s) that having (inter-gNB) handover ongoing.
If some of the (legacy) triggering criteria for sending a measurement report are fulfilled, the remote UE does not send any measurement report to the network but instead it starts the cell (re)selection procedure in order to establish a new Uu connection towards a (new) serving cell. In such a case, the PC5 connection with the relay UE may or may not be maintained.
The remote UE starts the relay discovery procedure
The remote UE starts the relay (re)selection procedure.
If the (inter-gNB) handover is being performed by the serving relay UE, the remote UE releases the current relay path and goes to RRC_IDLE/RRC_INACTIVE. This means that eventually the remote UE will reselect a new gNB or a new relay, perform RRC connection reestablishment and transit to RRC_CONNECTED again.

Alternatively, or in addition, new triggering criteria for sending a measurement report may be configured for a remote UE, for instance, different parameters (such as thresholds/offsets/hypothesis etc.) used in the measurement events may be configured which should be applied when the remote UE has received an indication from a relay UE that a (inter-gNB) handover procedure is being performed by the relay UE. The thresholds should be configured in a way that the remote UE will send the measurement report later compared to measurement reports triggered by the legacy triggering criteria.

In another embodiment, the indication sent by the remote UE, relay UE, or by the network is a one-bit indication where “1” means the path switch procedure or (inter-gNB) handover procedure are ongoing and “0” that the path switch procedure or (inter-gNB) handover procedure are not ongoing, or vice versa. Further, in another embodiment, the indication sent by the remote UE, relay UE, or by the network is a Boolean value where “true” means the path switch procedure or (inter-gNB) handover procedure are ongoing and “false” that the path switch procedure or (inter-gNB) handover procedure are not ongoing, or vice versa. Yet, in another embodiment, the indication is just a field (what type is it, does not matter) whether just the presence of this field means that the path switch procedure or (inter-gNB) handover procedure are ongoing and the absence of this field that the path switch procedure or (inter-gNB) handover procedure are not ongoing.

In one embodiment, 1) upon receiving an indication from the remote UE that there is a (inter-gNB) handover by the relay UE ongoing, or 2) an indication from the relay UE (i.e., can be a candidate or serving relay UE) that there is a path switch procedure ongoing by the remote UE, or 3) a measurement report from both the relay UE and remote UE, the network may perform at least one (or a combination) of the following actions:
Hold the sending of the RRC reconfiguration message to trigger the path switch procedure or the (inter-gNB) handover procedure only after one of the two procedures have been completed.
The network sends a first indication to the remote UE, when a (inter-gNB) handover procedure starts, in order to indicate that the measurement report sending is temporary forbidden. At the same time, the network sends a second indication, when the (inter-gNB) handover procedure has finished, that the measurement report sending is again allowed. Together with this indication, the network may also indicate the new gNB to which the relay UE has been handed over.
The network sends a first indication to the relay UE, when a path switch procedure starts, in order to indicate that the measurement report sending is temporary forbidden. At the same time, the network sends a second indication, when the path switch procedure has finished, that the measurement report sending is again allowed. Together with this indication, the network may also indicate to the relay UE whether the remote UE has switched his path to a (new) relay UE or to the direct Uu connection.
If the network receives a measurement report from both the relay UE and remote UE, the network triggers first one procedure (i.e., between the path switch and the (inter-gNB) handover) and once that this procedure is finished, it triggers the second procedure (i.e., between the path switch and the (inter-gNB) handover).
   How the network decides which procedure to trigger first, may be according to at least one (or a combination) of the following options:
      1. The network triggers first the procedure which measurement report was received first. E.g., if the network receives first the measurement report from the remote UE, then it triggers the path switch procedure first and then the (inter-gNB) handover procedure.
      2. The network triggers the procedure which priority is higher. This assumes that the path switch procedure and (inter-gNB) handover procedure are characterized with a priority that can be given:
by signal strength that the relay UE has with the serving gNB and remote UE has with the serving gNB or serving relay UE at the moment when the measurement report was sent
by LCH priority of the radio bearer on with the Uu connection and relay connection are operating
by a fixed priority decided by RAN or the core network or mobile operator.
The serving gNB of the remote UE sends an indication to the serving gNB of the candidate relay UE so that the serving gNB of the candidate relay UE can inform the candidate relay UE that the remote UE has a path switch ongoing and also perform some of the action described in this embodiment.
If the network receives a measurement report from both the relay UE and remote UE, the network may decide to trigger the (inter-gNB) handover procedure and release the sidelink relay connection.
If the network receives a measurement report from both the relay UE and remote UE, the network may decide to send the remote UE and/or the relay UE to RRC_IDLE or RRC_INACTIVE (or a combination of these two RRC states). In one embodiment, the solutions and methods described in all the previous embodiments the UE should use is decided by the gNB and communicated to the UE via dedicated RRC signaling of via system information. As another alternative, which option(s) the UE should use is decided by TX/RX UE or is pre-configured (hard-coded in the spec).

In another embodiment, for any of the all above embodiments, the signaling alternatives described will include at least one of the below

For signalling between gNBs:
X2/Xn signalling
F1 signaling
Inter-node RRC messages

For signaling between UE and the gNB:
RRC signaling
MAC CE
L1 signaling on channels such as PRACH, PUCCH, PDCCH
Control PDU of a protocol layer such as SDAP, PDCP, RLC or an adaptation layer which is introduced for responsible of duplication function

For signaling between UEs:
RRC signaling (e.g., PC5-RRC)
PC5-S signaling
Discovery signaling
MAC CE
L1 signaling on channels such as PSSCH, PSCCH, or PSFCH.
Control PDU of a protocol layer such as SDAP, PDCP, RLC or an adaptation layer which is introduced for responsible of duplication function

The methods and solutions proposed in this invention allow guarantee service continuity in case the path switch procedure and the (inter-gNB) handover procedure are triggered at the same time. In order to do so, the following options are proposed:
When the remote UE performs a path switch procedure, the remote UE sends an indication to the relay UE so that the relay UE can hold the sending of the measurement report to the gNB (that eventually may trigger an handover procedure).
   The same can be applied also to the relay UE. Meaning that if the relay UE is performing an (inter-gNB) handover procedure, the relay UE sends an indication to the remote UE so that the remote UE can hold the sending of the measurement report to the gNB (that eventually may trigger a path switch procedure).
When the gNB receives a measurement report from the remote UE or relay UE, before triggering the path switch or (inter-gNB) handover procedure it waits a certain amount of time in order to see if another measurement report is received either from the remote UE or relay UE.
   Once that both measurement reports are received, the gNB may decide to trigger only one procedure without causing any conflict between the patch switch and the (inter-gNB) handover procedure.
   Alternatively, once that both measurement reports are received, the gNB may decide to trigger one procedure first, and after this first procedure is completed, the gNB trigger the second one.
When the gNB triggers either a path switch or a (inter-gNB) handover procedure, both the remote UE and relay UE are informed by the gNB so that another procedure (e.g., a path switch or an (inter-gNB) handover procedure) is not triggered at the same time.

With the methods and solution disclosed in the present invention, the service continuity is guaranteed in case the path switch procedure and the (inter-gNB) handover procedure are triggered at the same time.

This will avoid losses in the connection that are particular important for reliability sensible application such as V2X or public safety.

1-18. (canceled)

19. A method in a first terminal device, the first terminal device having a second terminal device serving as a relay towards a first network node or being a candidate to serve as a relay towards the first network node or a second network node, the method comprising:
receiving a first indication from the second terminal device, the first indication indicating that the second terminal device is performing a handover procedure; and
performing an operation in response to receiving the first indication.

20. The method of claim 19, wherein said performing the operation comprises:
delaying, when a triggering criterion for transmitting a measurement report is fulfilled, transmission of the measurement report to the first network node.

21. The method of claim 20, wherein said delaying comprises:
delaying the transmission of the measurement report by a predetermined time length.

22. The method of claim 20, wherein said delaying comprises:
delaying the transmission of the measurement report until a second indication indicating that the handover procedure is completed is received from the second terminal device or the first network node.

23. The method of claim 19, wherein said performing the operation comprises:
transmitting, when a triggering criterion for transmitting a measurement report is fulfilled, the measurement report to the first network node, the measurement report containing the first indication indicating that the second terminal device is performing the handover procedure.

24. The method of claim 19, wherein said performing the operation comprises, when a triggering criterion for transmitting a measurement report is fulfilled:
initiating a cell reselection, relay discovery, or relay reselection procedure, or entering a Radio Resource Control, RRC, IDLE or INACTIVE state, without transmitting the measurement report to the first network node.

25. The method of claim 19, wherein said performing the operation comprises:
changing a triggering criterion for transmitting a measurement report to be more difficult to be fulfilled.

26. The method of claim 25, wherein the triggering criterion comprises at least one of a threshold, an offset, and a hypothesis.

27. The method of claim 20, wherein the measurement report includes one or more of:
a first link measurement between the first terminal device and the first network node,
a second link measurement between the first terminal device and the second network node,
a third link measurement between the first terminal device and the second terminal device, and
a fourth link measurement between the first terminal device and a third terminal device.

28. The method of claim 19, wherein said performing the operation comprises, when the second terminal device is the candidate to serve as the relay:
transmitting, when a triggering criterion for transmitting a measurement report is fulfilled, a measurement report to the first network node, the measurement report including a first link measurement between the first terminal device and the first network node and/or a second link measurement between the first terminal device and the second network node and/or a fourth link measurement between the first terminal device and a third terminal device, and excluding a third link measurement between the first terminal device and the second terminal device.

29. The method of claim 19, further comprising:
receiving, from the first network node or another control device, an instruction or configuration to perform the operation in response to receiving the first indication.

30. The method of claim 19, wherein:
the first indication is received directly from the second terminal device, or is forwarded by a third terminal device, using:
Radio Resource Control, RRC, signaling,
PC5 Signaling, PC5-S,
discovery signaling,
Medium Access Control, MAC, Control Element, CE,
Layer 1, L1, signaling, or
control Protocol Data Unit, PDU, of a protocol layer, or
the first indication is forwarded by the first network node using:
RRC signaling,
MAC CE,
L1 signaling, or
control PDU of a protocol layer.

31. The method of claim 19, wherein the first indication is a one-bit indication, a Boolean value, or a field whose presence indicates that the second terminal device is performing the handover procedure.

32-64. (canceled)

65. In a first terminal device, the first terminal device having a second terminal device serving as a relay towards a first network node or being a candidate to serve as a relay towards the first network node or a second network node, the second terminal device, comprising a transceiver, a processor and a memory, the memory comprising instructions executable by the processor whereby the second terminal device is operative to:
receive a first indication from the second terminal device, the first indication indicating that the second terminal device is performing a handover procedure; and
perform an operation in response to receiving the first indication.

66. In a first terminal device, the first terminal device having a second terminal device serving as a relay towards a first network node or being a candidate to serve as a relay towards the first network node or a second network node, a computer readable storage medium having computer program instructions stored thereon, the computer program instructions, when executed by a processor in the second terminal device, causing the second terminal device to:
receive a first indication from the second terminal device, the first indication indicating that the second terminal device is performing a handover procedure; and
perform an operation in response to receiving the first indication.

67-70. (canceled)
